(19) United States
(12) Patent Application Publication
(10) Pub. No.: US 2016/0210424 A1
(43) Pub. Date: Jul. 21, 2016

(54) COMPUTER IMPLEMENTED SYSTEM AND METHOD FOR ASSEMBLING A MEDICAL TREATMENT PLAN

(71) Applicant: Gaargle Solutions Inc., Montreal, Quebec (CA)

(72) Inventor: Pietro Di Battista, (US)

(21) Appl. No.: 14/403,452

(22) PCT Filed: Mar. 15, 2013
(86) PCT No.: PCT/CA2013/000256

§ 371 Date: Nov. 24, 2014

Related U.S. Application Data
(60) Provisional application No. 61/652,041, filed on May 25, 2012.

(51) Int. Cl. G06F 19/00

(52) U.S. Cl. CPC G06F 19/345; G06F 19/322

(57) ABSTRACT

A computer-implemented method of assembling a medical treatment plan for a patient. The method includes presenting, by a computer system, a first treatment option and a second treatment option. At the computer system, receiving a first selection of the first treatment option and receiving a second selection of the second treatment option. With the computer system, generating as a function of the received first selection of the first treatment option and the received second selection of the second treatment option, the medical treatment plan for the patient. In the computer system, storing the medical treatment plan for the patient. The first treatment option and the second treatment option are presented in an order corresponding to a pre-determined medical relationship between the first treatment option and the second treatment option.

### FIELD OF THE INVENTION

The present invention relates generally to the field of electronic medical record systems and more particularly to a method and system for assembling a medical treatment plan by medical professionals. Illustratively, the present invention may relate to a method and system for assembling dental treatment plans by dental professionals.

### BACKGROUND OF THE INVENTION

Traditionally, medical professionals have maintained individualized paper files for patients. These files typically contain information corresponding to a particular patient, and include material such as a patient's overall medical history, examination notes, lab reports, proposed treatment plans, and in some cases, billing and invoicing information.

There are disadvantages, however, associated with maintaining paper files. Among other things, they may be lost, damaged, or destroyed, are not readily accessible or searchable, and require a large amount of physical storage area.

In response to these disadvantages and others, in recent years, medical professionals have begun to transition to electronic medical record systems. These systems allow information to be electronically inputted and accessed, resulting in improvements in the efficiency of medical clinics, among other benefits. Additionally, these systems may be augmented with other features such as accounting, scheduling, and collaboration tools so as to create more comprehensive and useful systems.

Existing electronic medical record systems have disadvantages, however. For example, users may require extensive training to learn how to use the system; more generally, the system may operate in a fashion that does not correspond to the natural workflow used by medical professionals.

Accordingly, there is a need for a method and system for inputting and accessing medical information by medical professionals, which is intended to assist with eliminating or alleviating some or all of the aforementioned problems associated with the prior art approaches.

### SUMMARY OF THE INVENTION

In a first broad aspect of the present invention, there is provided a computer-implemented method of assembling a medical treatment plan for a patient comprising the steps of: presenting, by a computer system, a first treatment option and a second treatment option for the medical treatment plan; receiving, at the computer system, an indication that the first treatment option is to be administered to the patient; receiving, at the computer system, an indication that the second treatment option is to be administered to the patient; and storing, in the computer system, the medical treatment plan for the patient corresponding to the first treatment option and the second treatment option; wherein the first treatment option and the second treatment option are presented in an order corresponding to a pre-determined medical relationship between the first treatment option and the second treatment option.

In a second broad aspect of the present invention, there is provided a computer-implemented method of assembling a medical treatment plan for a patient comprising the steps of: presenting, by a computer system, a plurality of treatment options comprising at least a first treatment option and a second treatment option; presenting, by a computer system, a graphical representation corresponding to at least one anatomical portion of the patient; receiving, at the computer system, an indication of the selection of the first treatment option; receiving, at the computer system, an indication of the selection of an anatomical portion of the patient; storing, in the computer system, the medical treatment plan for the patient comprising giving a treatment corresponding to the first treatment option to the anatomical portion of the patient; wherein the first treatment option and the second treatment option are presented in an order corresponding to a pre-determined medical relationship between the first treatment option and the second treatment option.

In a third broad aspect of the present invention, there is provided a computer-implemented method of receiving medical information for a patient comprising the steps of: presenting, by a computer system, a first input tool and a second input tool; presenting, by a computer system, a graphical representation corresponding to at least one anatomical portion of the patient; receiving, at the computer system, an indication of the selection of one of the first input tool and the second input tool; receiving, at the computer system, an indication of the selection of an anatomical portion of the patient; storing, in the computer system, medical information associated with the selected input tool and the anatomical portion of the patient; and updating the graphical representation to comprise an indicator corresponding to the medical information that is associated with the selected input tool and the anatomical portion of the patient.

In a fourth broad aspect of the present invention, there is provided a computer-implemented method of scheduling a treatment, comprising the steps of receiving, at a first computer logged into a system using a first user account, a first indication that a treatment should be scheduled; transmitting, from the first computer to a second computer, a second indication that the treatment should be scheduled; storing, in the second computer, a third indication that the treatment should be scheduled; receiving, at a third computer and logged into the system using a second user account, from the second computer, an indication to present treatments that require scheduling; receiving, at the third computer logged into the system using the second user account, information corresponding to the treatment corresponding to the first indication; presenting, at the third computer logged into the system using the second user account, a graphical representation indicating that the treatment corresponding to the first indication should be scheduled; receiving, at the third computer logged into the system using the second user account, an indication that the treatment is scheduled for a given time; and updating, at the third computer logged into the system using the second user account, the graphical representation to stop indicating that the treatment corresponding to the first indication should be scheduled.

In a fifth broad aspect of the present invention, there is provided a system for scheduling appointments for a patient, comprising a computer operative to display a graphical user interface (GUI) and receive user input; wherein the GUI comprises a first GUI element corresponding to appointments that require scheduling, and a second GUI element corresponding to missed appointments that require rescheduling; and wherein the computer is further operative to perform the steps of the following method: present, through the GUI and in association with the first GUI element, an indication that a treatment requires scheduling; receive, at the computer, an indication that the treatment is scheduled for a given time; update, at the computer, the GUI to remove the indication that the treatment requires scheduling; receive, through the GUI and in association with the second GUI element, an indication that the treatment was missed; record, at the computer, an indication that the treatment was missed; and present, through the GUI and in association with the second GUI element, an indication that the treatment requires scheduling.

In a sixth broad aspect of the present invention, there is provided a computer-implemented method of assembling a medical treatment plan for a patient, the method comprising: presenting, by a computer system, a first treatment option and a second treatment option; receiving, at the computer system, a first selection of the first treatment option; receiving, at the computer system, a second selection of the second treatment option; generating, with the computer system and as a function of the received first selection of the first treatment option and the received second selection of the second treatment option, the medical treatment plan for the patient; and storing, in the computer system, the medical treatment plan for the patient; wherein the first treatment option and the second treatment option are presented in an order corresponding to a pre-determined medical relationship between the first treatment option and the second treatment option.

In an alternative embodiment, the medical treatment plan comprises indications that a first treatment and a second treatment are to be administered to the patient, wherein the first and second treatments respectively correspond to the first and second treatment options.

In an alternative embodiment, the order comprises the first treatment option being presented before the second treatment option; and

In an alternative embodiment, the medical relationship comprises the first treatment being administered before the second treatment if both of the first and second treatments are to be administered to the patient.

In an alternative embodiment, the order comprises the chronological sequence in which the first and second treatments are administered.

In an alternative embodiment, the medical relationship between the first treatment option and the second treatment option comprises one of (a) the first and second treatments being administered jointly to the patient; and (b) the first and second treatments each being administered to the exclusion of the other.

In an alternative embodiment, the method further comprising: receiving, at the computer system, an indication that a third treatment option different from the first and second treatment options should be presented in a given position relative to the first and second treatment options; wherein the presenting, by a computer system, a first treatment option and a second treatment option for the medical treatment plan further comprises presenting the third treatment option, and wherein the third treatment option is presented in the given position relative to the first and second treatment options.

In an alternative embodiment, at least one of the first and second treatment options comprises a submenu.

In an alternative embodiment, at least one of the first and second treatment options corresponds to a specific treatment.

In an alternative embodiment, presenting, by a computer system, the first treatment option and the second treatment option comprises presenting the first treatment option and the second treatment option as part of a list of at least three treatment options.

In a seventh broad aspect of the present invention, there is provided a computer-implemented method of assembling a medical treatment plan for a patient, the method comprising: presenting, by a computer system, a first treatment option and a second treatment option; presenting, by the computer system, a graphical representation corresponding to a plurality of individual anatomical elements of the patient; receiving, at the computer system, a selection of one of the first and second treatment options; receiving, at the computer system, a selection of at least one individual anatomical element of the patient; generating, with the computer system and as a function of the received selection of one of the first and second treatment options and the received selection of at least one individual anatomical element of the patient, the medical treatment plan for the patient; and storing, in the computer system, the medical treatment plan for the patient; wherein the first treatment option and the second treatment option are presented in an order corresponding to a pre-determined medical relationship between the first treatment option and the second treatment option.

In an alternative embodiment, the graphical representation corresponding to a plurality of individual anatomical elements of the patient comprises an odontogram.

In an alternative embodiment, the graphical representation corresponding to a plurality of individual anatomical elements of the patient comprises at least one indicator of a finding related to at least one of the plurality of individual anatomical elements of the patient.

In an alternative embodiment, the medical treatment plan comprises an indication that a first treatment corresponding to the selected one of the first and second treatment options is to be administered to the selected at least one individual anatomical element of the patient.

In an alternative embodiment, the method further comprising: receiving, at the computer system, a further selection of the first and second treatment options; receiving, at the computer system, a further selection of at least one individual anatomical element of the patient; wherein the medical treatment plan for the patient further comprises an indication that a second treatment corresponding to the further selected one of the first and second treatment options is to be administered to the further selected at least one individual anatomical element of the patient.

In an eight broad aspect of the present invention, there is provided a computer-implemented method for manipulating a medical treatment plan for a patient, the method comprising: receiving, at a computer system, indications corresponding to first and second treatments to be administered to the patient; associating, by the computer system, at least one of the first and second treatments with a pre-determined duration; and presenting, by the computer system, graphical representations of the first and second treatments and the associated pre-determined duration.

In an alternative embodiment, associating, by the computer system, at least one of the first and second treatments with a pre-determined duration comprises associating, by the computer system, the first and second treatments with a first and second pre-determined duration, respectively, and wherein the method further comprises: receiving, at the computer system, an indication that the first and second treatments should be grouped together; and presenting, by the computer system, an updated graphical representation of the first and second treatments grouped together and associated with the first and second pre-determined durations.

In an alternative embodiment, the graphical representations of the first and second treatments are presented in a first order, and wherein the method further comprises: receiving, at the computer system, an indication that the first and second treatments should be in a second order; and presenting, by the computer system, an updated graphical representation of the first and second treatments in the second order.

In an alternative embodiment, the computer system is a first computer system, the method further comprising: receiving, at the first computer system, an indication to schedule at least one of the first and second treatments; transmitting, from the first computer system to a second computer system, a first indication that the at least one of the first and second treatments should be scheduled; transmitting, from the second computer system to a third computer system, a second indication that the at least one of the first and second treatments should be scheduled; presenting, at the third computer system, a graphical representation that the at least one of the first and second treatments should be scheduled; receiving, at the third computer system, an indication that the at least one of the first and second treatments is scheduled for a given time; and presenting, at the third computer system, an updated graphical representation that the at least one of the first and second treatments has been scheduled.

In an alternative embodiment, the method further comprising: receiving, at the third computer system, an indication that the patient missed the at least one of the first and second treatments scheduled for the given time; and presenting, at the third computer system, a graphical representation that the at least one of the first and second treatments should be rescheduled.

In a ninth broad aspect of the present invention, there is provided a computer readable memory storing computer executable instructions thereon that when executed by a computer performs the method of at least one of the first eight broad aspects of the present invention.

Additional aspects and advantages of the present invention will be apparent in view of the description which follows. It should be understood, however, that the detailed description, while indicating embodiments of the invention, are given by way of illustration only, since various changes and modifications within the spirit and scope of the invention will become apparent to those skilled in the art from this detailed description.

### BRIEF DESCRIPTION OF THE DRAWINGS

With reference to embodiments thereof, the invention will next be described in relation to the drawings, which are intended to be non-limiting examples of various embodiments of the present invention, in which:

FIG. 1 is a block diagram of an electronic medical record system in accordance with an exemplary embodiment of the present invention.

FIG. 2 is an exemplary screenshot of a graphic user interface (GUI) screen for a user to log into the electronic medical record system of FIG. 1.

FIG. 3 is an exemplary screenshot of a GUI screen for displaying a summary of information for a user logged into the electronic medical record system of FIG. 1.

FIG. 4 is an exemplary screenshot of a GUI screen for a user to input new patient information into the electronic medical record system of FIG. 1.

FIG. 5 is a flow diagram depicting a new patient creation operation at a client computer in the electronic medical record system of FIG. 1.

FIG. 6 is an exemplary screenshot of a GUI screen for a user to input a patient's medical history into the electronic medical record system of FIG. 1.

FIG. 7 is an exemplary screenshot of a GUI screen displayed after a user has inputted a patient's medical history into the electronic medical record system of FIG. 1.

FIG. 8 is a flow diagram depicting a medical history input operation at a client device in the electronic medical record system of FIG. 1.

FIG. 9 is an exemplary screenshot of a GUI screen for displaying a summary of information about a patient to a user logged into the electronic medical record system of FIG. 1.

FIG. 10 is an exemplary screenshot of a GUI screen for a user to input the results of the general portion of a dental examination of a patient into the electronic medical record system of FIG. 1.

FIG. 11 is an exemplary screenshot of a GUI screen for a user to input the results of dental portion of a dental examination of a patient into the electronic medical record system of FIG. 1.

FIG. 12 is an exemplary screenshot of a GUI screen for a user to input the presence of decay during a dental examination of a patient into the electronic medical record system of FIG. 1.

FIG. 13 is an exemplary screenshot of a GUI screen for a user to input information regarding pockets during a dental examination of a patient into the electronic medical record system of FIG. 1.

FIG. 14 is an exemplary screenshot of a GUI screen for a user to input information related to endodontics during a dental examination of a patient into the electronic medical record system of FIG. 1.

FIG. 15 is an exemplary screenshot of a GUI screen for a user to input the results of the intraoral portion of a dental examination of a patient into the electronic medical record system of FIG. 1.

FIG. 16 is an exemplary screenshot of a GUI screen for a user to input a prognosis during a dental examination of a patient into the electronic medical record system of FIG. 1.

FIG. 17 is an exemplary screenshot of a GUI screen for displaying a summary of a dental examination of a patient conducted using the electronic medical record system of FIG. 1.

FIG. 18 is a flow diagram depicting a dental examination input operation at a client device in the electronic medical record system of FIG. 1.

FIG. 19 is a flow diagram depicting client device receiving user input to GUI screens depicted by exemplary screenshots FIGS. 11-14.

FIG. 20 is an exemplary screenshot of a GUI screen for inputting a treatment plan for a patient via the electronic medical record system of FIG. 1.

FIG. 21 is an exemplary screenshot of a GUI screen for inputting diagnostic tools into a treatment plan for a patient via the electronic medical record system of FIG. 1.

FIG. 22 is an exemplary screenshot of a GUI screen for inputting scaling root planning into a treatment plan for a patient via the electronic medical record system of FIG. 1.

FIG. 23 is an exemplary screenshot of a GUI screen for inputting treatment of caries into a treatment plan for a patient via the electronic medical record system of FIG. 1.

FIG. 24 is an exemplary screenshot of a GUI screen for inputting build up treatments into a treatment plan for a patient via the electronic medical record system of FIG. 1.

FIG. 25 is an exemplary screenshot of a GUI screen for inputting provisionalization treatments into a treatment plan for a patient via the electronic medical record system of FIG. 1.

FIG. 26 is a flow diagram depicting a treatment plan input operation at a client device in the electronic medical record system of FIG. 1.

FIG. 27 is an exemplary screenshot of a GUI screen for editing the default treatment plan submenus of the electronic medical record system of FIG. 1.

FIG. 28 is an exemplary screenshot of a GUI screen where a sedation submenu is inserted into the treatment plan submenus of the electronic medical record system of FIG. 1.

FIG. 29 is an exemplary screenshot of a GUI screen for displaying a treatment plan summary for a patient using the electronic medical record system of FIG. 1.

FIG. 30 is an exemplary screenshot of a GUI screen for displaying a modified treatment plan summary for a patient using the electronic medical record system of FIG. 1.

FIG. 31 is an exemplary screenshot of a GUI screen for assigning a treatment to a staff member for scheduling through the electronic medical record system of FIG. 1.

FIG. 32 is an exemplary screenshot of a GUI screen for scheduling a treatment through the electronic medical record system of FIG. 1.

FIG. 33 is an exemplary screenshot of a GUI screen for scheduling and marking scheduled treatments as missed through the electronic medical record system of FIG. 1.

FIG. 34A is a flow diagram depicting a treatment scheduling operation at a first client device in the electronic medical record system of FIG. 1.

FIG. 34B is a flow diagram depicting a treatment scheduling operation at a second client device in the electronic medical record system of FIG. 1.

FIG. 35 is an exemplary screenshot of a GUI screen for inputting an appointment into the electronic medical record system of FIG. 1.

FIG. 36 is an exemplary screenshot of a GUI screen for inputting a progress note corresponding to a treatment into the electronic medical record system of FIG. 1.

FIG. 37 is a flow diagram depicting a progress note input operation at a client device in the electronic medical record system of FIG. 1.

### DETAILED DESCRIPTION OF THE INVENTION

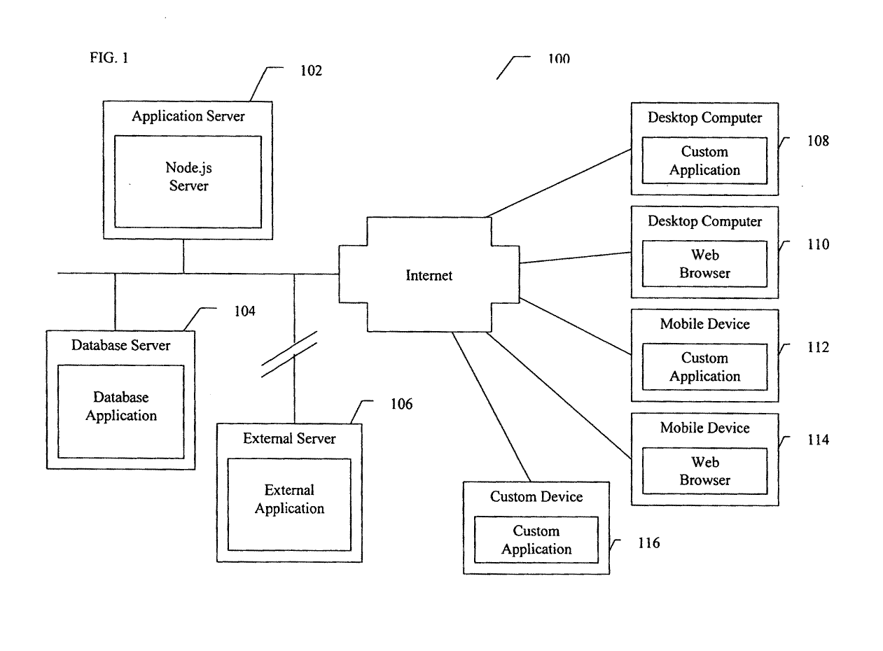

FIG. 1 illustrates an electronic medical record system 100 exemplary of an embodiment of the present invention. System 100 may include an application server 102, database server 104, external server 106 and client devices, desktop computers 108, 110, and mobile devices 112, 114. System 100 may further include a custom device 116 as a client device. Each of the aforenoted components of system 100 may be interconnected by way of the Internet in a conventional manner. Alternatively, database server 104, external server 106 and application server 102 may be interconnected by a local area network (LAN) in a conventional manner instead of the Internet. In a further alternative, one or more of client devices 108, 110, 112, 114, 116 may also be interconnected with the remainder of system 100 by a LAN in a conventional manner instead of the Internet.

Each of application server 102, database server 104 and external server 106 may operate in a conventional manner to service, individually or jointly, one or more of client devices 108, 110, 112, 114, 116. It will be appreciated that while application server 102, database server 104 and external server 106 are illustrated as separate components, they may hosted on one computing device, or on other configurations of computing devices, as will be known to those skilled in the art. It will also be known to those skilled in the art that system 100 may comprise other components, such as firewalls, backup servers, and load balancers, either configured as separate computing devices, or combined together with one or more of the aforementioned components into various configurations. More generally, system 100 may be variously configured to be operating on a single computing device locally, a plurality of computer devices over a LAN, a plurality of computer devices over a virtual private network (VPN), or a plurality of computer devices over the Internet generally. Further, system 100 may be variously configured to be a shared system used by a plurality of potentially unrelated users, or a private system used by a single individual or a single group of related users.

Application server 102 may include a Node.js™ server for, for example, instantiating a HTTP server for delivering and receiving content using the hypertext transfer protocol (HTTP), such as HTML documents, images, style sheets, and JavaScript. In other embodiments of the present invention, application server 102 may comprise a HTTP server (such as Apache HTTP Server™) and a JavaServer Pages™ server (such as Apache Tomcat™). In other embodiments of the present invention, protocols other than HTTP may also be used.

Database server 104 may include a database application for, for example, organizing, storing, and accessing data necessary to implement electronic medical record system 100. In some embodiments of the present invention, a database application such as MySQL™ may be employed.

External server 106 may include an external application for, for example, communicating with users of system 100 via channels of communication other than the Internet, such as SMS, MMS, and phone calls.

Desktop computers 108, 110 may access system 100. More specifically, desktop computers 108, 110 may communicate with one or more of servers 102, 106, by way of the Internet, using a standard web browser (e.g. Safari™, Firefox™, Internet Explorer™) or using a custom application. Likewise, mobile devices 112, 114 (e.g. Apple iPhone™, Apple iPad™, Blackberry™, Blackberry Playbook™) may communicate with one or more of servers 102, 106, by way of the Internet, using a standard mobile web browser (e.g. Blackberry Browser™, Safari™) or using a custom mobile application.

Custom device 116 may be a device provided by the provider of electronic medical record system 100 for the primary or incidental purpose of accessing system 100 in the form of, for example, a mobile dental examination cart. Custom device 116 may also be a device provided by a third-party, but compatible with electronic medical record system 100.

In all of the illustrative embodiments of the present invention hereinafter described in greater detail and illustrated through exemplary screenshots of GUI screens, the client device is mobile device 114 presenting and providing user access to GUI screens through a standard mobile web browser. In these embodiments, a user first instructs a mobile web browser executing on mobile device 114 to access application server 102, for example, by accessing a specific domain name or Internet Protocol (IP) address. Hereafter, mobile device 114, application server 102, database server 104 and such other computing devices as required and as known to those skilled in the art operate in a cooperative manner, again in a manner known to those skilled in the art, to form system 100 that operates as described in greater detail below to provide, generally speaking, a web application.

The implementation details related to such systems are well known. Accordingly, a skilled person in the art will appreciate the meaning of such abstract concepts as, for example, (i) a computing device “presenting” a form or GUI element to a user (for example, through a computer display), (ii) a computing device “receiving” user input (for example, through a keyboard, mouse, touch screen, gesture intervace, or microphone), (iii) a user “selecting” a button or other GUI element (for example, through clicking with a mouse or tapping with a finger on a touch sensitive display), (iv) a presented form being “updated” in response to user input (for example, by displaying the user input), (v) a system “knowing” information (for example, by storing relevant data in an appropriate data storage device and being capable of processing input and the stored data to determine an appropriate output), (vi) a selection of a GUI element “causing” a computing device to take some particular action (for example, by virtue of the computing device receiving said user input of a selection of the GUI element, processing this input, and determining that it should take the particular action), and, more generally, (vii) system 100 being responsive to a user's interaction with a client device by virtue of the client device receiving user input and, in cooperation with application server 102, database server 104 and such other computing devices as may be required, processing this input pursuant to computer software executing on one of more of the computing devices, and responding in some way, including modifying the output of the client device that user is interacting with.

In particular, it will be appreciated that in the illustrative embodiment, mobile device 114 is a tablet computer (having a touch sensitive display) accessed primarily through touch and touch gestures, but that any other suitable form of human computer interface may be substituted or combined therewith, including, for example, keyboard and mouse input, gesture input, or voice input. Well known types of specific input may also be employed, such as clicking, tapping, double clicking, double tapping, dragging and dropping, sliding, and pinching.

Moreover, while the illustrative embodiments hereinafter described primarily relate to dentistry, embodiments of the present invention may relate to other medical fields such as cardiology and ophthalmology.

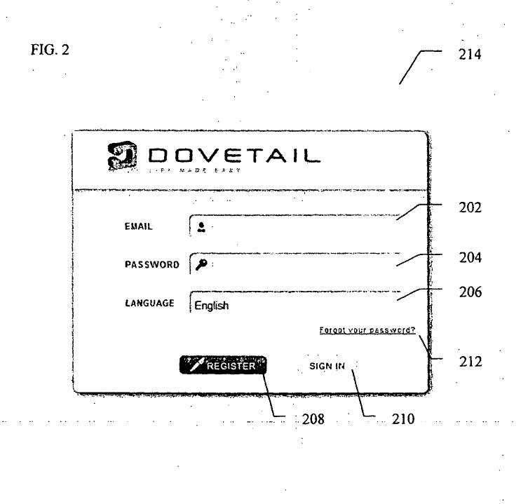

System 100 may require a user to login before providing access to system 100. With reference to FIG. 2, login form 214 may be presented to a user upon an initial attempt to access system 100. Prior art features such as email/username field 202, password field 204, register button 208, sign in button 210, and forgot password link 212 may be included to allow a user to provide credentials corresponding to an existing user account to login, or, if the user does not have appropriate credentials, to first register a new user account or to engage a password recovery feature of system 100 to recover credentials associated with an existing user account. Such login, registration, and password recovery functionality are well known to those skilled in the art. In other embodiments of system 100, other login mechanisms also well known to those skilled in the art may be employed, such as biometric scanners. In still other embodiments of system 100, no login mechanism may be employed, for example, if physical access to system 100 is restricted and all access to system 100 may be presumed to be authorized.

As would also be well known to those skilled in the relevant art, user accounts may have multiple purposes. For example, by requiring users to login, system 100 is made aware of the identity of the user and may present customized information to the user including information that should not be publicly accessible; that is, user accounts may assist with addressing personalization and security needs, among other things; particularly since electronic medical record systems may contain highly sensitive and personal information.

As a further aspect of system 100 potentially employing the use of user accounts, system 100 may also permit granular sharing of information and functionality between multiple users. This functionality is well known to those skilled in the relevant art, and may include the use of features such as delegation, groups, and permissions. For example, system 100 may be configured through a suitable configuration GUI screen to permit a group of users (corresponding to the staff of a single clinic) to all have access to information corresponding to patients of the clinic, but each user may be permitted to access different information and functionality depending upon their role in the clinic. An office manager may have global access, including to the configuring GUI screen, whereas the front-desk receptionist may be restricted to only scheduling and contact information.

Login form 214 may further include language field 206, for example in the form of a drop down menu item, to allow a user to select a language (e.g. English, French, Italian). This language choice may cause system 100 to interact with a user in the selected language, including, in some embodiments, by providing a machine translation of existing text (e.g. medical notes) from a first language different from the selected language into the selected language. In other embodiments, the selected language may, for example, determine the database used by system 100 to conduct spell checking upon text inputted into system 100 by a user. In other embodiments, system 100 may access information available to it such as HTTP request header information to predict the language that a user may desire, and pre-select such language in language field 206.

It will also be appreciated that in some circumstances, the use of warnings, errors, confirmations, and other communication tools may be appropriate. Such tools are well known to those in the relevant art and not otherwise described in this specification. For example, a user may receive a warning message if the user attempts to login to system 100 with incorrect credentials, or, if a user attempts to cancel a form input operation or initiates a delete operation, the user may first be challenged with a confirmation screen prior to system 100 completing the requested operation.

Error checking and field validation may also be completed by system 100 with regard to login form 214 (and more generally, with regard to all forms and other user input fields described herein). For example, mobile device 114 may ensure email/username field 202 and password field 204 each correspond to a particular regular expression, and if not, may present an error message to the user and request new credentials from the user. Similar error checking and field validation may be conducted by application server 102, regardless of whether or not mobile device 114 is designed to do error checking itself.

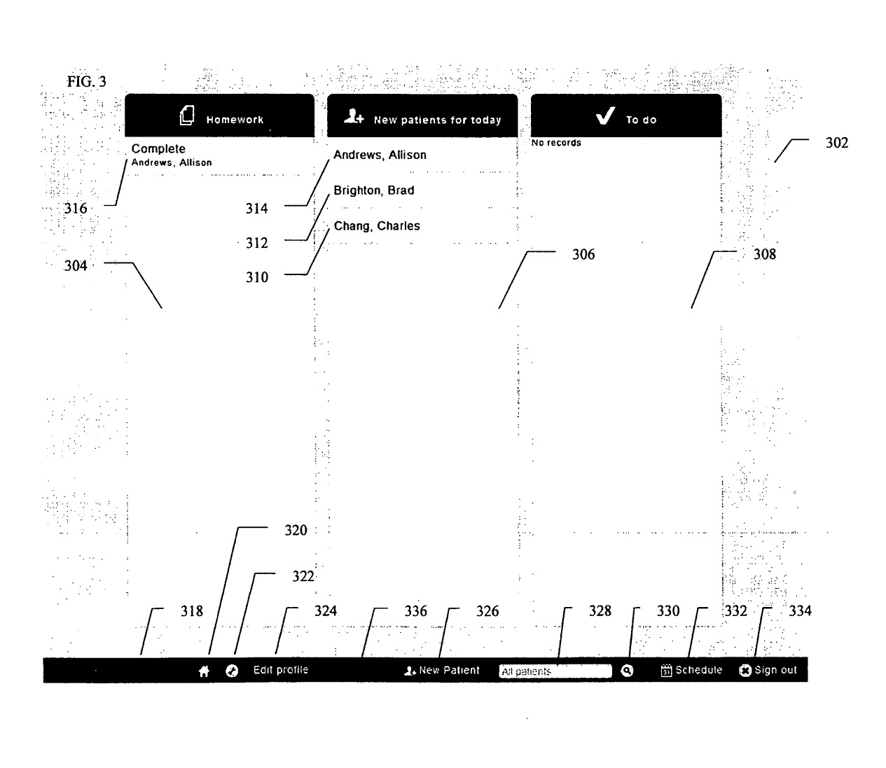

With reference to FIG. 3, dashboard 302 may be presented to a user upon successfully logging into system 100. Dashboard 302 may have the purpose of presenting a user with an overview of his or her status in relation to system 100, as well as common tasks. For example, dashboard 302 may comprise, among other things, homework list 304, new patient list 306, todo list 308 and toolbar 336.

Homework list 304 may list tasks that a user is required to complete. For example, homework list 304 includes exemplary homework item 316 corresponding to charting that a user must do in relation to the exemplary patient Allison Andrews. Homework list 304 may include one or more homework items that may constitute different tasks and types of tasks, and homework items may in turn include text or icons to describe the task and/or type of task. For example, homework item 316 indicates that it relates to a previously completed “Complete” examination of the exemplary patient Allison Andrews. Homework items, such as homework item 316, may further operate as buttons so that, if selected by a user, system 100 undertakes an action such as presenting a GUI suitable for the user to complete the homework item, or providing a contextual menu to the user so that further actions may be taken. In other embodiments of the present invention, additional operations may also be conducted on the homework items. For example, homework items may be flagged, tagged, categorized, re-ordered, or manually deleted by users.

System 100 may determine the tasks to present in homework list 304 through a variety of means. In an illustrative embodiment of the present invention, system 100 may be configured to require a progress note to be created following any patient appointment with a given medical professional, and if no such progress note is created, that a corresponding task be presented in the homework list of that medical professional. In other embodiments of the present invention, system 100 may provide a GUI screen for users to add items to be presented in their own homework list or the homework list of other users. Again as would be known to those skilled in the relevant art, for homework list 304 and, more generally, any other information presented to a user, there may not necessarily be a list or corresponding data structure stored in a data storage device of system 100 corresponding directly to such information; rather, system 100 may compile and construct this information on demand for the purpose of presentation.

New patient list 306 may list patients that a user has an appointment with on a given day, namely, the day on which the user is currently logged into system 100 and presented with dashboard 302. For example, new patient items 310, 312, 314 may be listed in new patient list 306 and may include text or icons to describe the patient and/or type of appointment. For example, new patient items 310, 312, 314 respectively indicate that the user has appointments with exemplary patients Allison Andrews, Brad Brighton, and Charles Chang. New patient items, such as new patient items 310, 312, 314, may further operate as buttons so that, if selected by a user, system 100 undertakes an action such as displaying a summary of information about the patient, as described in greater detail hereinbelow, or providing a contextual menu to the user so that further actions may be taken. In other embodiments of the present invention, additional operations may be conducted on the new patient items. For example, new patient items may be flagged, tagged, categorized, re-ordered, or manually deleted by users.

System 100 may determine the items to present in new patient list 306 through a variety of means. In an illustrative embodiment of the present invention, system 100 may store scheduled appointments between medical professionals and patients, as described hereinbelow, and system 100 may search such scheduled appointments to identify patients with which a given user has appointments with on a given day. All such patients may be presented in new patient list 306, or additional filtering may be first conducted.

Todo list 308 may also list tasks that a user is required to complete and may be similar to homework list 304. In one embodiment of the present invention, homework list 304 and todo list 308 may be distinguished in that system 100 presents tasks related to charting in homework list 304, whereas tasks related to external communication (e.g. reviewing lab reports, returning phone calls) are presented in todo list 308.

Although in the illustrative embodiment of the present invention dashboard 302 comprises homework list 304, new patient list 306, and todo list 308, as described hereinabove, in other embodiments of the present invention, dashboard 302 may comprise a different number of lists that present different information. More generally, dashboard 302 may comprise any number of lists that present information to a user in a convenient format, such as lists of incoming electronic messages or voicemail, clinic information or news, or personal tasks and reminders. Even more generally, dashboard 302 may comprise information presented in formats other than lists. For example, dashboard 302 may comprise an estimate of a user's daily billings and whether a target amount has been met.

Dashboard 302 may also comprise toolbar 336. Toolbar 336 in turn may comprise any or all of the following:
(a) username 318 for presenting an indicator of the user currently logged into system 100;
(b) home button 320 that, if selected by a user, causes system 100 to present dashboard 302 to the user if system 100 is currently presenting a different GUI screen to the user, as described hereinbelow;
(c) edit configuration button 322 that, if selected by a user, causes system 100 to present a GUI screen to the user for modifying details related to the configuration of a user's account, such as clinic information, its hours and staff, and its number of rooms;
(d) edit profile 324 that, if selected by a user, causes system 100 to present a GUI screen to the user for modifying details related to the user's profile, such as his or her name and address;
(e) new patient button 326 that, if selected by a user, causes system 100 to initiate a new patient creation operation as described hereinbelow;
(f) patient search field 328 that provides a field for a user to input patient identification information;
(g) patient search button 330 that, if selected by a user, causes system 100 to search for existing patients using the information inputted into patient search field 328, and present the search results to the user through a GUI screen;
(h) schedule button 332 that, if selected by a user, causes system 100 to present a GUI screen having scheduling functionality, as described hereinbelow; and
(i) signout button 334 that, if selected by a user, causes system 100 to log the user out and present login form 214.

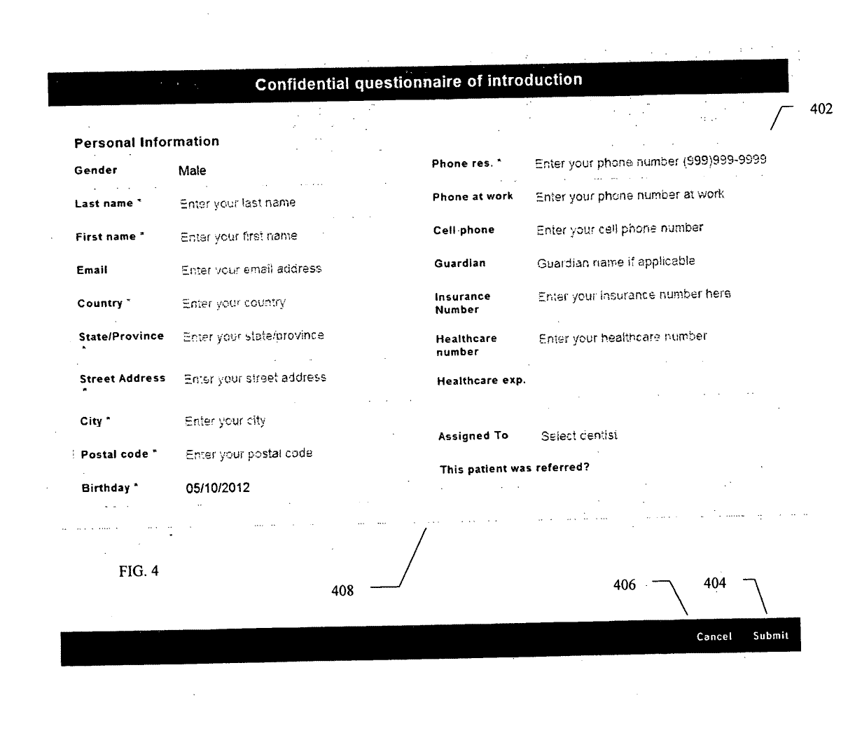

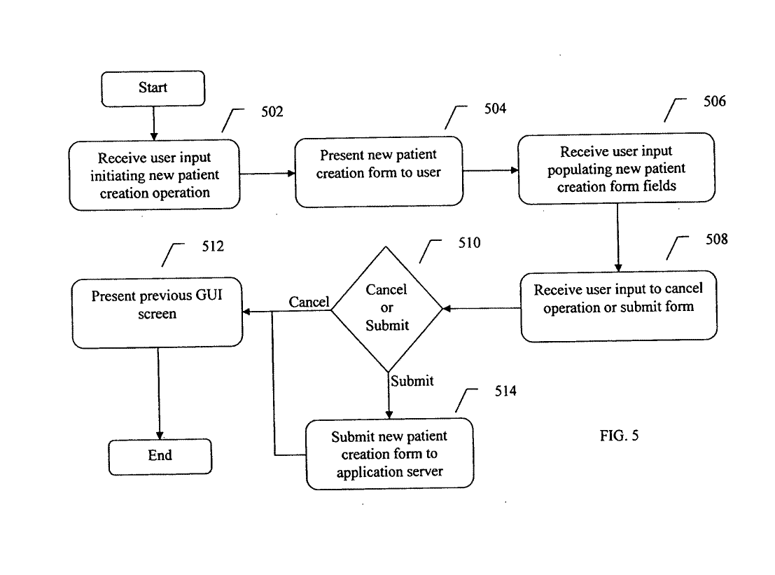

FIG. 4 is an exemplary screenshot of a GUI screen for a user to input new patient information. FIG. 5 is a corresponding flow diagram depicting a new patient creation operation at a client device such as exemplary mobile device 114. With reference to FIG. 4 and FIG. 5, the aforementioned new patient creation operation may be described. With regard to the new patient creation operation and the flow diagram of FIG. 5, and, more generally for all operations and flow diagrams described herein, while there may be described and depicted a particular sequence of steps, it will be known to the person skilled in the relevant art that variations in the order may be sometimes made (although in other circumstances, the sequence may be important). Moreover, in some circumstances, there may be other possible steps (and paths thereto), even where a plurality of possibilities is already depicted. For example, in some situations, a signout button such as signout button 334 may be available to be selected by a user at any point in time, in which case any operation currently in progress, such as a new patient creation operation, may be terminated by selecting the signout button. Alternatively, in other situations, if a new operation is commenced partway through a current operation, upon the termination of the new operation, system 100 may be designed to permit the user to continue with the previous operation where he or she left off.

At step 502, mobile device 114 receives user input for initiating a new patient creation operation. In an embodiment of the present invention, this input may comprise a user's selection of new patient button 326 of FIG. 3. Subsequently, at step 504, mobile device 114 may present new patient creation form 402 to the user. In this embodiment of the present invention, new patient creation form 402 may comprise new patient creation form fields 408, submit button 404, and cancel button 406. While not depicted, in some embodiments mobile device 114 may need to first communicate with application server 102 to receive sufficient information to present new patient creation form 402. More generally, in some embodiments system 100 may be configured so that only a portion of the computer code and information required to cause mobile device 114 to perform as described herein is provided to mobile device 114 upon its initial connection to application server 102. As it is well known to the skilled person in the relevant art that mobile device 114 may be designed to query and communicate with application server 102 to obtain additional material as required, this aspect of system 100 will not be further described herein.

At step 506, mobile device 114 may receive user input populating new patient creation form fields 408. New patient creation form fields 408 may comprise one or more optional or required fields (and types of fields) corresponding to a new patient's personal information. For example, new patient creation form fields 408 may, among other things, correspond to a new patient's sex, name, address, and phone number. With regard to new patient creation form 402 and the forms described more generally throughout this specification, each form may be comprised of one or more fields, each being optional or required as appropriate given the nature of the form and the input already received, and of a variety of types, such as text fields, text boxes, radio buttons, drop down menus, combo boxes, lists, checkboxes, wheels and so forth. These options are well known to those skilled in the relevant art.

At step 508, mobile device 114 further receives user input to cancel the new patient creation operation or to submit new patient creation form 402. User input to cancel the new patient creation operation may comprise a user's selection of cancel button 406. Alternatively, user input to submit new patient creation form 402 may comprise a user's selection of submit button 404.

At step 510, mobile device 114 determines, on the basis of what user input was received at step 508, whether to cancel the new patient creation operation, or to submit new patient creation form 402 to application server 102. If mobile device 114 determines it is to cancel the new patient creation operation, at step 512, mobile device 114 presents the previous GUI screen displayed prior to commencing the new patient creation operation. For example, if the new patient creation operation was initiated by means of a user's selection of new patient button 326 while dashboard 302 was presented, then dashboard 302 may be presented at step 512. If mobile device 114 determines it is to submit new patient creation form 402, then mobile device 114 may compile and submit the input received at step 506 to application server 102 at step 514, then proceed to present the previous GUI screen at step 512, as described above. Alternatively, after mobile device 114 submits new patient creation form 402, mobile device 114 may proceed to present an alternative GUI screen instead of the previous GUI screen.

More generally, while most forms described throughout this specification are described to comprise buttons that may be selected to cause mobile device 114 to compile and submit information to application server 102, in other embodiments of the present invention, automatic steps may be taken to periodically or constantly submit this information to application server 102, for example, to ensure information is not lost should mobile device 114 suffer a hardware failure in the middle of an operation. These and other alternatives for receiving and storing user input are well known to those skilled in the relevant art.

With regard to the aforementioned, and more generally, it will also be readily apparent to a person skilled in the relevant art that application server 102 may be configured to receive and respond appropriately to any requests or submissions that mobile device 114 makes to application server 102, and more generally, communicate and cooperate with the other computing devices of system 100 to achieve the herein described functionality. As noted previously, implementing system 100 as herein described to include, among other things, cooperating computing devices application server 102 and mobile device 114 is well within the capabilities of the skilled person in the relevant art.

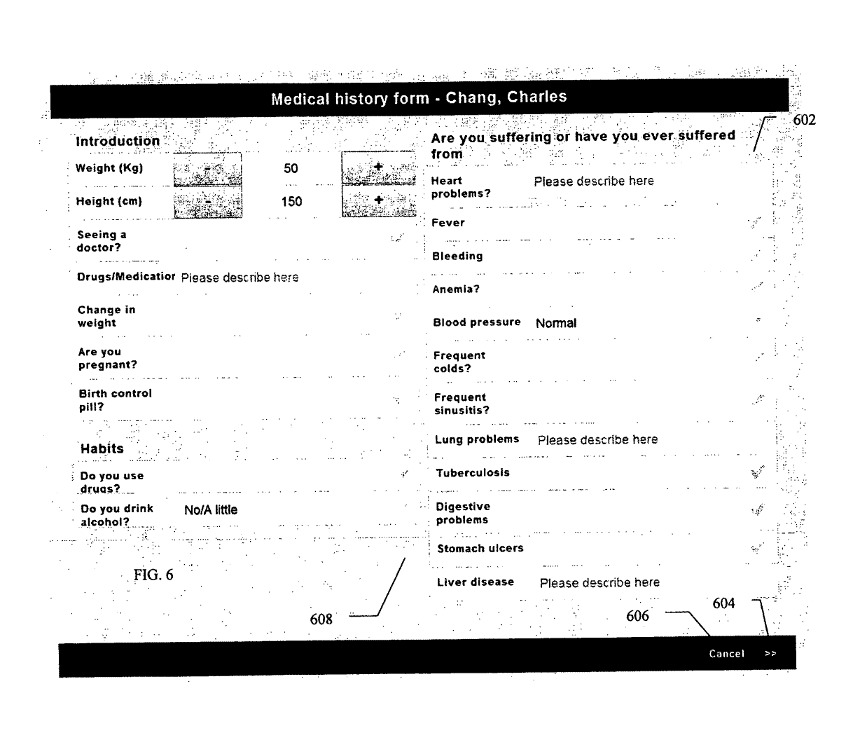

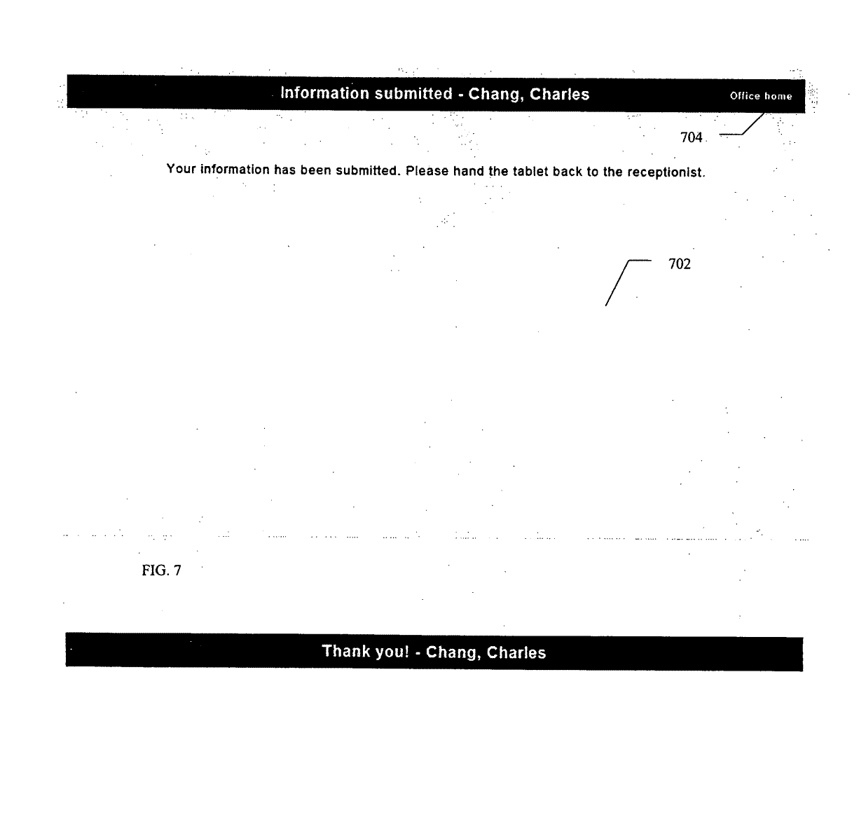

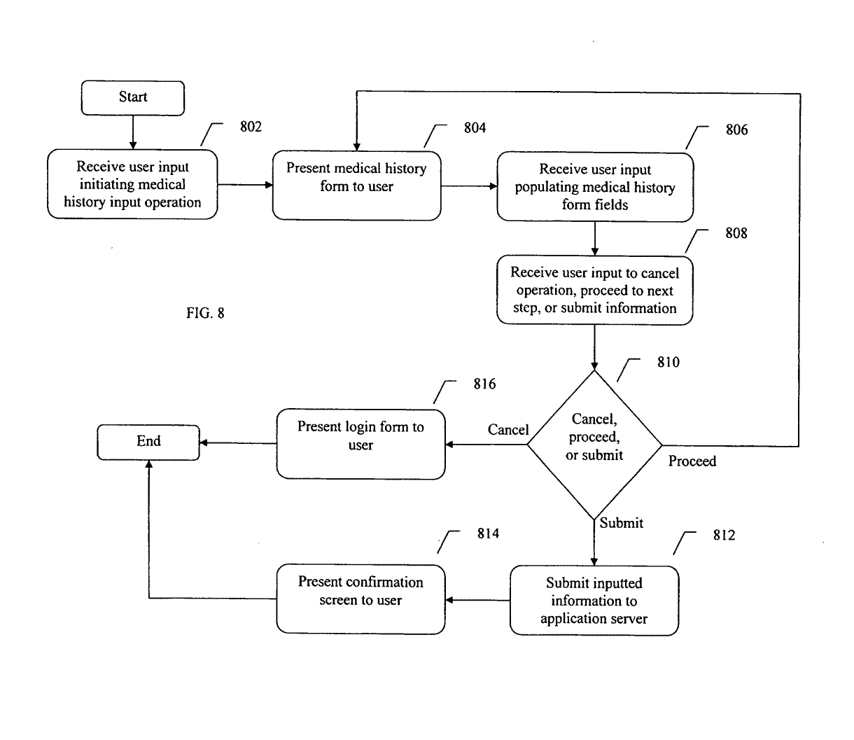

FIG. 6 is an exemplary screenshot of a GUI screen for a user to input a patient's medical history. FIG. 7 is an exemplary screenshot of a GUI screen displayed after a user has inputted a patient's medical history. FIG. 8 is a corresponding flow diagram depicting a medical history input operation at a client device such as exemplary mobile device 114. With reference to FIG. 6, FIG. 7, and FIG. 8, the aforementioned new patient creation operation may be described.

At step 802, mobile device 114 receives user input for initiating a medical history input operation. In an embodiment of the present invention, this input may comprise a user's submission of new patient creation form 402 so that at step 804 medical history form 602 may be presented to the user as the aforementioned alternative GUI screen. In another embodiment of the present invention, the user input may comprise a user's selection of one of new patient items 310, 312, 314 of dashboard 302 wherein no medical history has been previously inputted for the corresponding patient.

As noted above, at step 804 mobile device 114 presents medical history form 602 to the user. In this embodiment of the present invention, medical history form 602 may comprise medical history form fields 608, next step button 604, and cancel button 606.

At step 806, mobile device 114 receives user input populating medical history form fields 608. Medical history form fields 608 may comprise one or more optional or required fields (and types of fields) corresponding to a new patient's medical history. For example, medical history form fields 608 may, among other things, correspond to the weight, height, and past incidence of specific medical conditions. In some embodiments of the present invention, all fields may be optional and accordingly, no user input is necessarily received at this step. More generally, this may be the case with regard to all forms described herein; that is, the steps of receiving user input populating forms as described herein in relation to various operations may, in circumstances where the form contains only optional fields, be potentially skipped entirely by a user.

As described previously, mobile device 114 may also conduct error checking and field validation on the above user input. As a further example of such error checking, mobile device 114 may be configured to conduct more complex error checking such as ensuring that, if user input is received indicating that the patient is a woman, that a specific medical condition exclusive to men is not also received.

At step 808, mobile device 114 further receives user input to cancel the medical history input operation, proceed to a next step, or submit the inputted medical information. In the illustrative embodiment of the present invention, medical history form 602 only comprises cancel button 606 and next step button 604. Accordingly, user input to cancel the medical history input operation may comprise a user's selection of cancel button 606. Alternatively, user input to proceed to a next step may comprise a user's selection of next step button 604.

At step 810, mobile device 114 determines, on the basis of what user input was received at step 808, whether to cancel the medical history input operation, proceed to a next step, or to submit the inputted information.

If mobile device 114 determines it is to cancel the medical history input operation, at step 816, mobile device 114 proceeds to log the user out and present login form 214 to the user.

If mobile device 114 determines it is to proceed to a next step, it may return to step 804 but present a different medical history form than medical history form 602 comprising different medical history form fields than medical history form fields 608. Steps 804, 806, 808, 810 may be repeated so that mobile device 114 receives user input populating one or more medical history forms comprising medical history form fields. All but the last presented medical history form may comprise next step buttons and cancel buttons. The last medical history form may comprise a cancel button and a submit button. In the illustrative embodiment of the present invention, mobile device 114 may be configured to present three medical history forms, each of the first two medical history forms comprising buttons to cancel the operation or proceed to a next step, the final form comprising buttons to cancel the operation or submit the inputted information to the application server.

If mobile device 114 determines it is to submit the inputted information, then mobile device 114 may compile and submit the input received at step 806 (corresponding to the user populating each of the one or more medical history forms) to application server 102 at step 812. Subsequently, mobile device 114 may present confirmation screen 702 to the user at step 814. In the illustrative embodiment of the present invention, mobile device 114 also logs the user out at step 814 so that further user selection of office home button 704 located on confirmation screen 702 causes mobile device 114 to present login form 214 to the user.

In another embodiment of the present invention, either before, together with, or after receiving user input initiating the medical history input operation at step 802, mobile device 114 may provide means for the user to indicate whether, at step 814, the user should be logged out. In some embodiments, such logging out may be appropriate if, for example, mobile device 114 is provided to a patient to input his or her own medical history, in which case once the medical history input operation is complete, such patient should be prevented from accessing system 100. Alternatively, in other embodiments, such logging out may be inappropriate if, for example, a medical professional is the user inputting a patient's medical history into mobile device 114, in which case once the medical history input operation is complete, it may not be necessary to prevent the user (i.e. the medical professional) from continuing to access system 100. This alternative may operate similarly with respect to step 816—where the user is not logged out, instead of presenting login form 214, mobile device 114 may present the previous GUI screen displayed prior to commencing the medical history input operation.

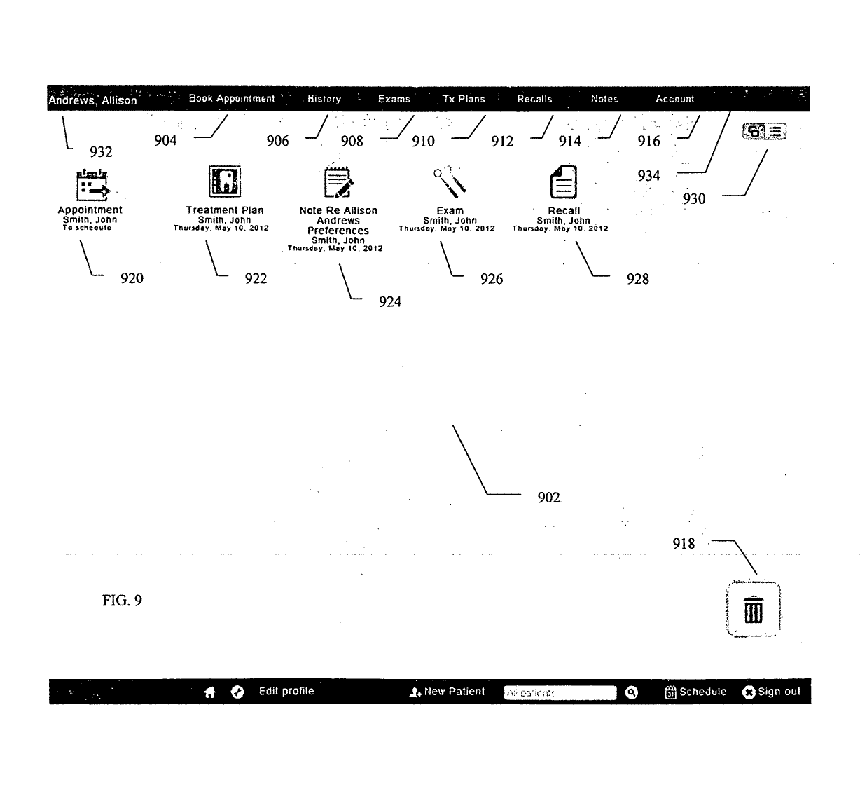

With reference to FIG. 9, patient summary 902 and context menu 934 may be presented to a user to display, generally, a summary of information and tools related to a patient to a user logged into system 100. As noted above, system 100 may present patient summary 902 and context menu 934 for a given patient, for example, upon the selection by a user of one of new patient items 310, 312, 314. In other embodiments of the present invention, this summary may be presented in response to a search for a patient using patient search field 328 and patient search button 330.

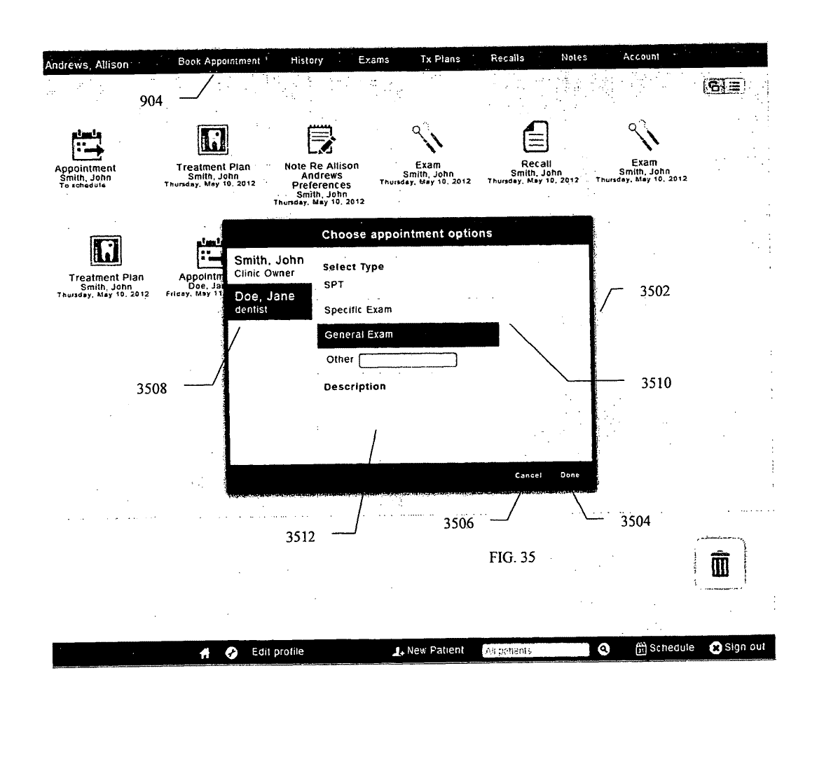

Context menu 934 may comprise, for example, any or all of the following:
(a) patient name 932 for presenting an indicator of the patient that patient summary 902 relates to.
(b) book appointment button 904 that, if selected by a user, causes system 100 to present a scheduling form, as described hereinbelow with reference to FIG. 35.
(c) history button 906 that, if selected by a user, causes system 100 to present patient summary 902 to the user if system 100 is currently presenting a different GUI screen to the user.
(d) exams button 908 that, if selected by a user, causes system 100 to present a GUI screen providing options to the user to initiate a dental examination input operation or to access the results of a previously completed dental examination input operation, such dental examination input operation described in greater detail hereinbelow.
(e) treatment plans button 910 that, if selected by the user, causes system 100 to present a GUI screen providing options to the user to initiate a treatment plan input operation or to access the results of a previously completed treatment plan input operation, such treatment plan input operation described in greater detail hereinbelow.
(f) recalls button 912 that, if selected by the user, causes system 100 to present a GUI screen providing options to the user to initiate a recall input operation or to access the results of a previously completed recall input operation. In one embodiment of the present invention, a recall input operation may comprise mobile device 114 receiving an indication from a user to initiate a recall input operation, presenting a recall form to the user that may comprise a variety of fields corresponding to information typically recorded in relation to a recall appointment, receiving input from the user populating one or more of the fields of the recall form, receiving an indication from the user to submit the input to application server 102, and submitting the received input to application server 102. Accessing the results of a previously completed recall input operation may comprise system 100 presenting to a user through a GUI screen the information previously inputted in a recall input operation.
(g) notes button 914 that, if selected by the user, causes system 100 to present a GUI screen providing options to the user to initiate a note input operation or to access the results of a previously completed note input operation. In one embodiment of the present invention, a note input operation may comprise mobile device 114 receiving an indication from a user to initiate a note input operation, presenting a text input field to the user, receiving text input from the user, receiving an indication from the user to submit the text input to application server 102, and submitting the received text input to application server 102. Accessing the results of a previously completed note input operation may comprise system 100 presenting to a user through a GUI screen the text previously inputted in a note input operation.

Patient summary 902 may comprise, for example, patient record items (such as appointment item 920, treatment plan item 922, notes item 924, exam item 926, and recall item 928), view selector buttons 930, and trash icon 918.

View selector buttons 930 may provide means for a user to toggle between a presentation of patient record items in icon form (as depicted in FIG. 9), or in list form (not shown).

Trash icon 918 may provide means for a user to remove patient record items from patient summary 902. For example, a user may conduct drag and drop treatment plan item 922 over trash icon 918, thereby causing system 100 to remove treatment plan item 922 from patient summary 902. With regard to this drag and drop, and more generally, with regard to all drag and drop operations described herein, the reverse may also be permitted. For example, in some embodiments, trash icon 918 may be dragged and dropped over treatment plan item 922 to cause system 100 to remove treatment plan item 922 from patient summary 902.

Patient record items such as appointment item 920, treatment plan item 922, notes item 924, exam item 926, and recall item 928 may correspond to elements of a given patient's record, as in this illustrative example, the patient Allison Andrews. Patient record items 920, 922, 924, 926, 928 may further include text or icons to describe the nature of the patient record item. For example, appointment item 920 comprises an informative icon and information indicating that the appointment is with John Smith; treatment plan item 922, exam item 926, and recall item 928 each comprise an informative icon and information indicating that each such patient record item was created by John Smith on May 10, 2012; and notes item 924 comprises an informative icon and an extract from the note (i.e. the text input received through a previously completed note input operation, as briefly described above).

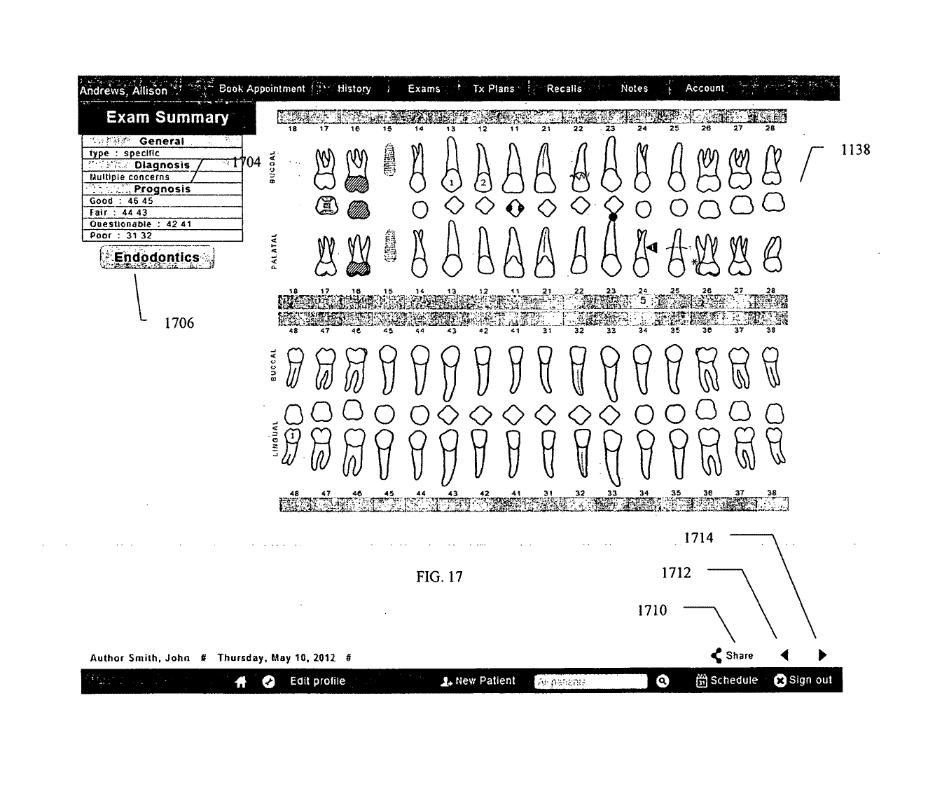

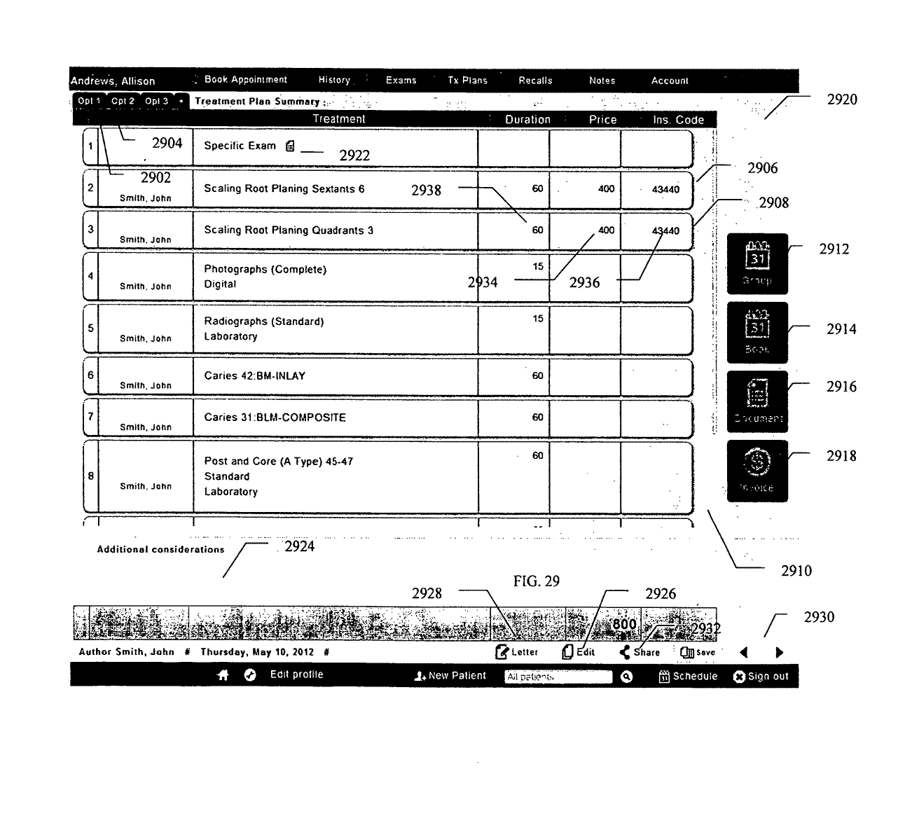

Patient record items 920, 922, 924, 926, 928 may further operate as buttons so that, if selected by a user, system 100 undertakes an action. For example, the selection of notes item 924 may cause system 100 to display the previously entered note. In another embodiment of the present invention, the selection of treatment plan item 922 may cause system 100 to present a treatment plan summary, as described below in greater detail with reference to FIG. 29, or the selection of exam item 926 may cause system 100 to present an exam summary, as described below in greater detail with reference to FIG. 17.

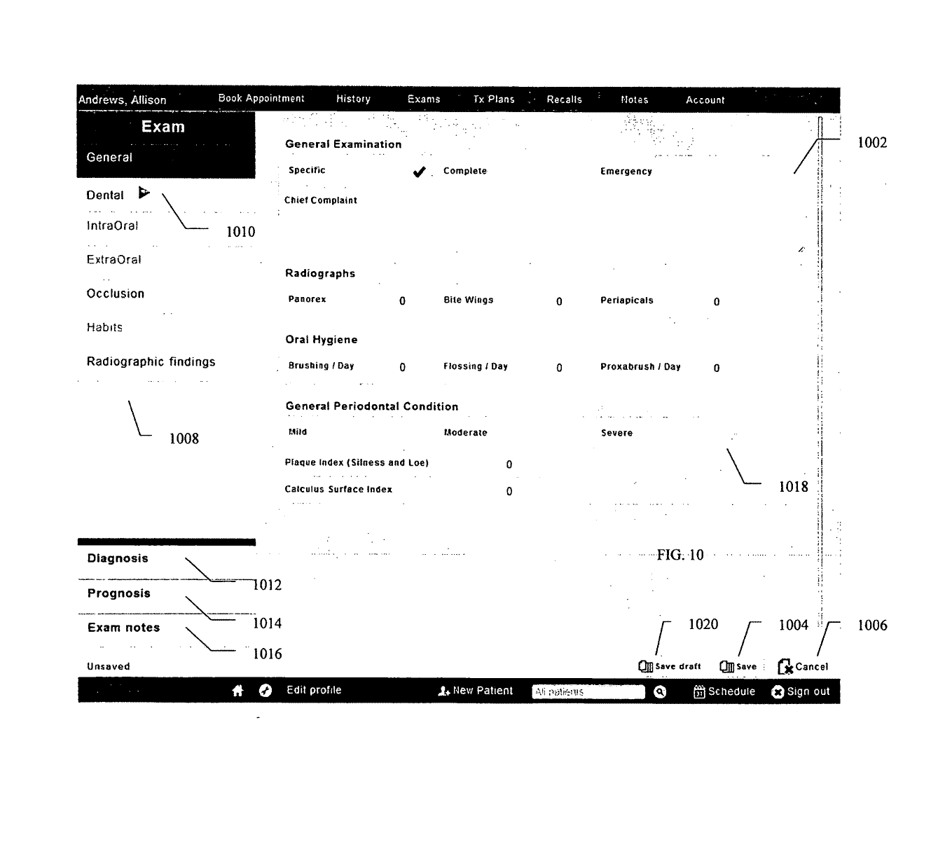

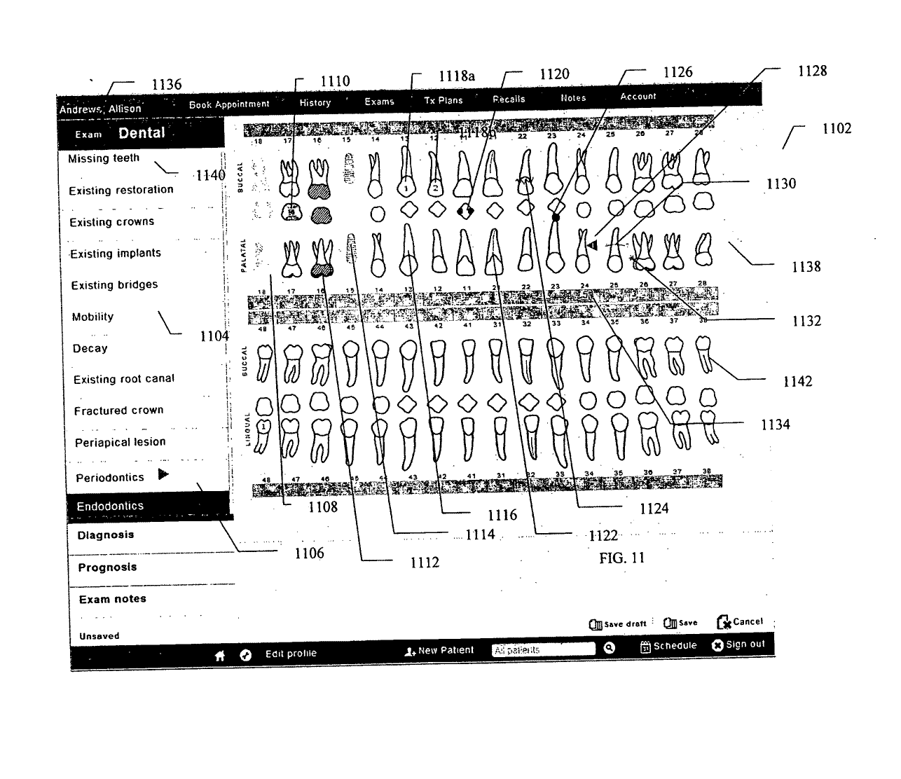

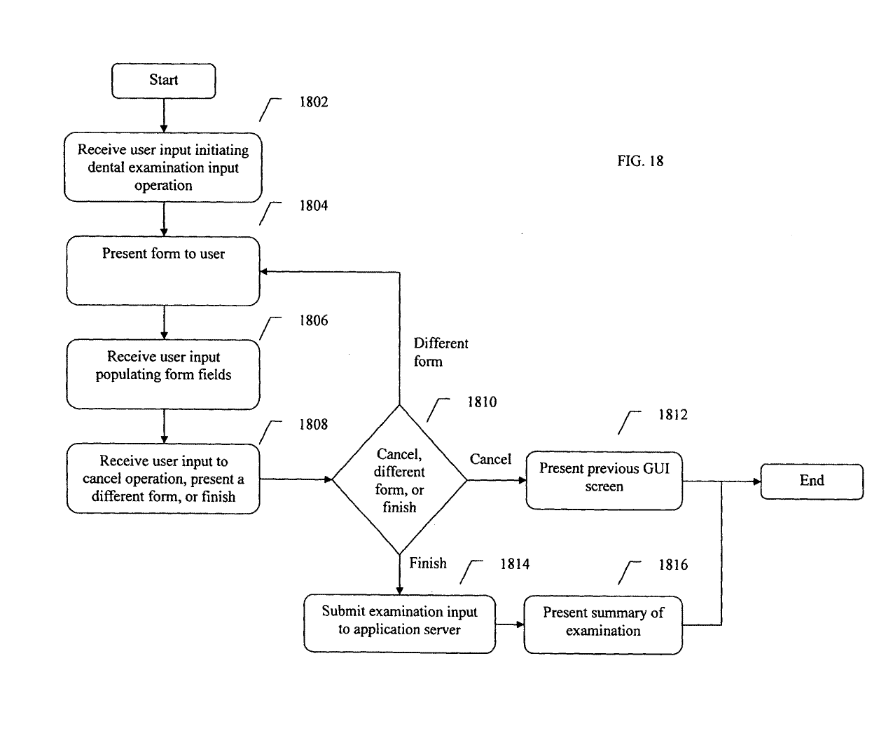

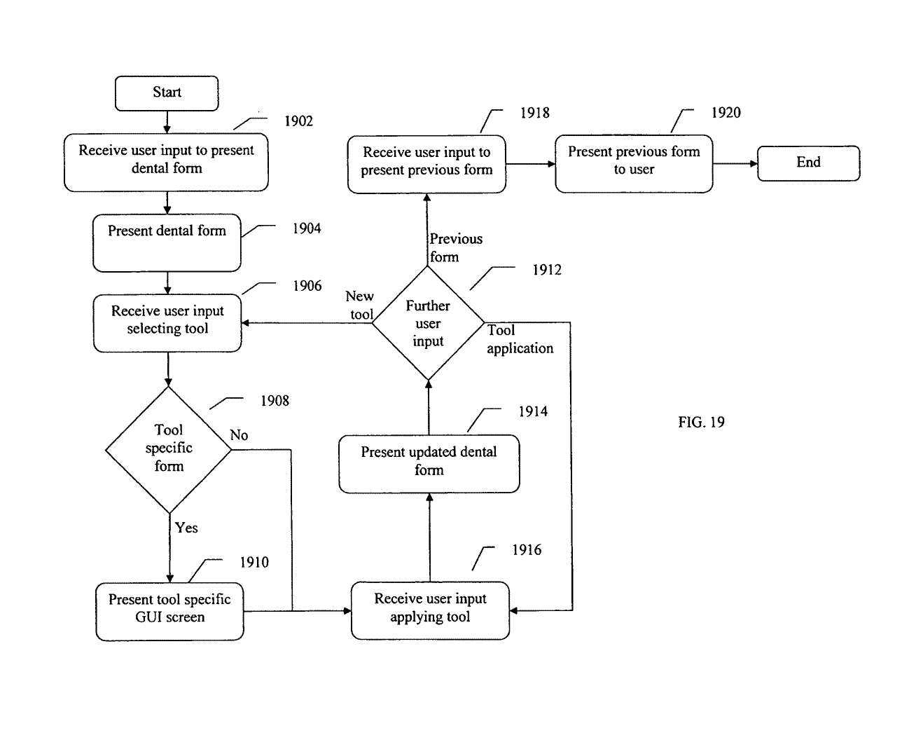

FIGS. 10-17 are exemplary screenshots of GUI screens corresponding to a dental examination input operation. FIG. 18 is a corresponding flow diagram depicting generally a dental examination input operation. FIG. 19 is a flow diagram depicting receiving user input to the forms depicted by FIGS. 11-14. With reference to FIGS. 10-17, FIG. 18, and FIG. 19, the aforementioned dental examination input operation may be described.

At step 1802, mobile device 114 receives user input for initiating a dental examination input operation. In an embodiment of the present invention, this input may comprise a user selecting exams button 908 to cause the aforedescribed options to be presented, and thereafter selecting a presented option of initiating a dental examination input operation. The patient associated with this dental examination input operation may already be known by system 100, as in this illustrative embodiment, or system 100 may be configured to query the user to determine the associated patient.

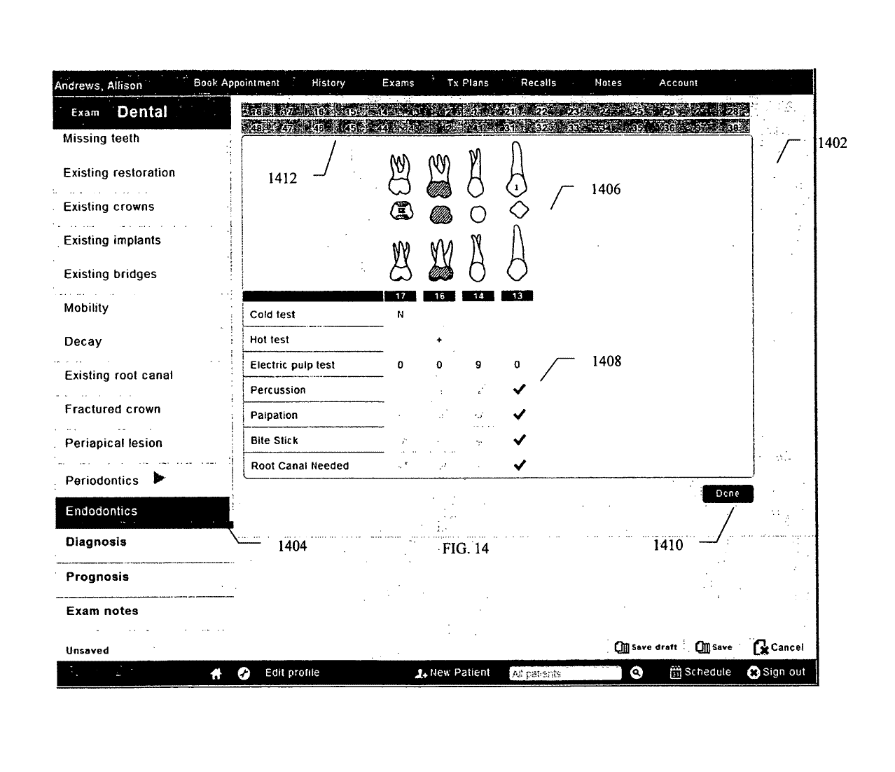

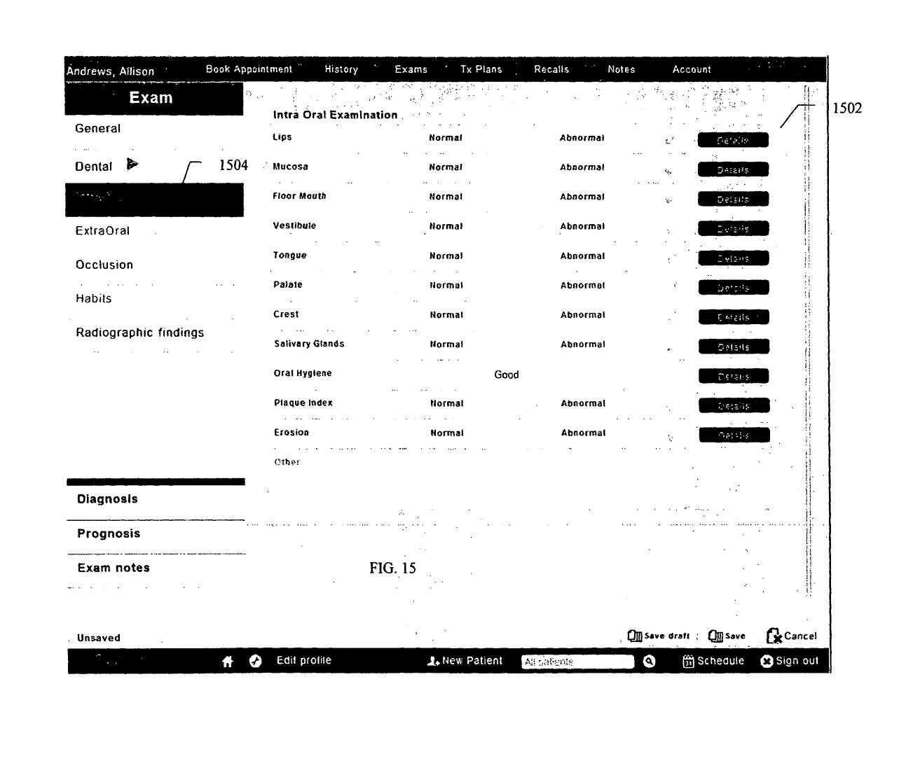

At step 1804, mobile device 114 presents a form to user, the form designed to receive input relating to a dental examination. In the illustrative embodiment of the present invention, a dental examination input operation is associated with a plurality of forms each designed to receive specific information from the user corresponding to a dental examination. For example, general examination form 1002 (see FIG. 10) is a form to receive information that relates generally to a dental examination, dental form 1102 (see FIG. 11) is a form to receive information that relates to specific teeth, endodontics form 1402 (see FIG. 14) is a form to receive information that relates generally to endodontics, and intraoral form 1502 (see FIG. 15) is a form to receive information that relates generally to intraoral aspects of a dental examination. Additional options are depicted by form options 1008, such as forms designed for extraoral aspects, occlusions, habits, and radiographic findings.

As illustrated by FIG. 10, general examination form 1002 may be the default first form that is presented to a user by mobile device 114. This form may comprise a variety of fields that at step 1806 may be populated through mobile device 114 receiving user input. For example, a user may select severe option 1018 to mark the patient as having a general periodontal condition of a severe nature. Additional, general examination form 1002 (and the other related forms) may comprise save draft button 1020 that may be selected by a user at any time to cause mobile device 114 to compile and submit the information received thus far through the dental examination input operation to application server 102 to store as a temporary draft that may be accessed by the user should, for example, mobile device 114 suffer a hardware or software failure prior to the intended completion of the operation including step 1814, as described herein.

At step 1808, mobile device 114 receives user input to cancel the dental examination input operation, present a different form, or finish the operation. In the illustrative embodiment, user input to cancel the dental examination input operation may comprise a user's selection of cancel button 1006, user input to present a different form may comprise a user's selection of any of form options 1008, diagnosis form option 1012, prognosis form option 1014, or exam notes form option 1016, and user input to finish the operation may comprise a user's selection of save button 1004.

At step 1810, mobile device 114 determines, on the basis of what user input was received at step 1808, whether to cancel the dental examination input operation, present a different form, or finish the operation.

If mobile device 114 determines it is to cancel the dental examination input operation, at step 1812, mobile device 114 may present the previous GUI screen displayed prior to commencing the dental examination input operation. For example, if the operation was initiated while patient summary 902 was displayed, mobile device 114 may again present patient summary 902.

If mobile device 114 determines it is to present a different form, it may return to step 1804 but present a different form that corresponds to the user input received at step 1808. For example, if the user input received at step 1808 was a selection of dental form option 1010, mobile device 114 may present dental form 1102 (see FIG. 11). This cycle comprising step 1804, step 1806, step 1808 and step 1810 may be undertaken repeatedly until the mobile device 114 receives user input at step 1808 that causes it to determine at step 1810 that it should cancel the dental examination input operation or finish the operation. In some embodiments of the present invention, if for a given iteration of the aforementioned cycle the form presented to the user at step 1804 was previously presented to the user in one or more previous iterations, then the form presented to the user at step 1804 in the given iteration may automatically reflect any user input previously provided at step 1806 during the previous one or more iterations.

Before proceeding to describe the step of mobile device 114 determining that it is to finish the dental examination input operation, another illustrative embodiment of step 1806 (and related steps) is next described in greater detail with reference to FIGS. 11-14 and FIG. 19.

At step 1902, mobile device 114 receives user input to present dental form 1102 to the user, such user input comprising, for example, a user's selection of dental form option 1010. At step 1904 (corresponding to step 1806), mobile device 114 may present dental form 1102 to the user, dental form 1102 comprising in this illustrative embodiment odontogram 1138 and tool items 1104.

At step 1906, mobile device 114 may receive user input selecting one of tool items 1104. This user input may comprise a user selecting missing teeth tool 1140. Exemplary tool items 1104 are depicted in FIG. 11 that may correspond to various findings that may relate to specific teeth in the context of a dental examination.

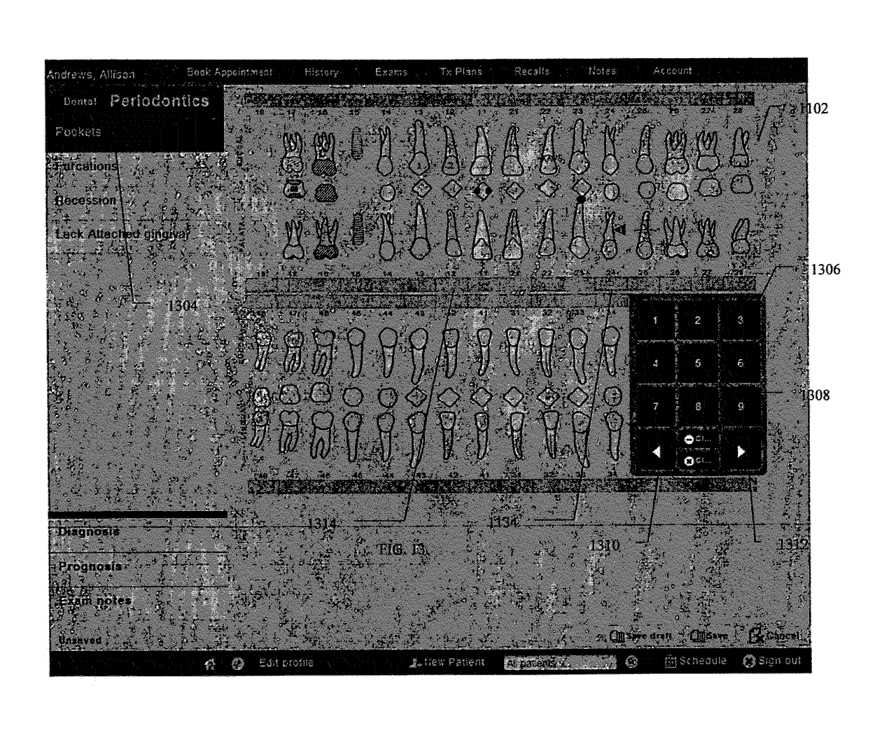

At step 1908, mobile device 114 determines whether there is a specific form associated with the selected one of tool items 1104. For example, no specific form is associated with missing teeth tool 1140, whereas one is so associated with pockets tool 1304 (accessed through user selection of peridontics submenu 1106), as described in greater detail with reference to FIG. 13.

Assuming no specific form is associated with the selected one of tool items 1104, mobile device 114 does not perform step 1910 comprising presenting a GUI screen that includes the specific form. Rather, mobile device 114 proceeds to receive user input applying the tool at step 1916. This user input may comprise a user selecting a tooth depicted by odontogram 1138 (which, prior to such selection, may appear by default similar to normal tooth icon 1142). As will be clear to the person skilled in the art, these steps may correspond to a user selecting one of the provided tools and applying the tool to a tooth depicted by odontogram 1138 for the purpose of recording in system 100 characteristics of the tooth of a patient undergoing an examination in real-life. For example, the user may be a medical practitioner such as a dentist who is conducting an examination on a patient and using system 100 to record information about the teeth of the patient, such as the patient missing a particular tooth or having an existing crown on another tooth.

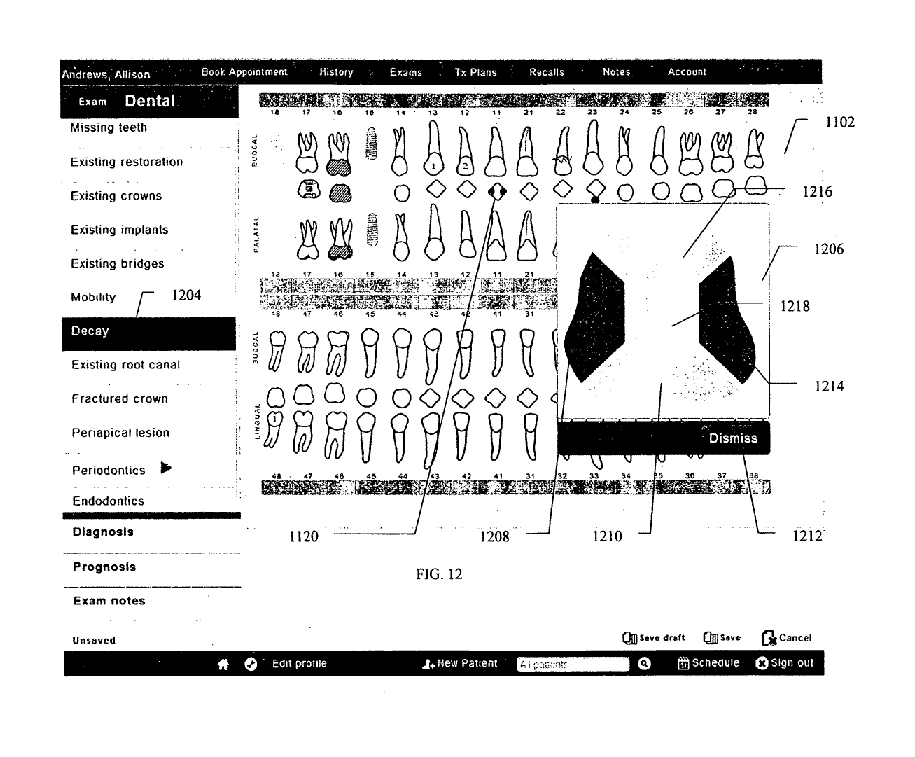

In another illustrative embodiment of the present invention, mobile device 114 may also present a more detailed form for receiving additional input specific to a particular tool once mobile device 114 receives user input applying the tool at step 1916 (this further step not shown in FIG. 19). For example, FIG. 12 illustrates a form presented after a user has applied decay tool 1204 to a tooth, namely, tooth form 1206 comprising left tooth portion 1208, back tooth portion 1210, right tooth portion 1214, front tooth portion 1216, top tooth portion 1218, and dismiss button 1212. The purpose of this particular tooth form 1206 may be to enable a user to provide additional information in relation to the decay of the specific tooth. For example, a user may toggle one or more of tooth portions 1208, 1210, 1214, 1216, 1218 to indicate that such portions exhibit decay. Exemplary FIG. 12 depicts tooth form 1206 reflecting user input that left tooth portion 1208 and right tooth portion 1214 exhibit decay. The user may select dismiss button 1212 to close or dismiss the form (i.e. cause mobile device 114 to stop presenting tooth form 1206).

As described previously, mobile device 114 may also conduct error checking and field validation on the above user input. As a further example of such error checking, mobile device 114 may be configured to conduct more complex error checking such as ensuring that, if user input is received indicating that a tooth is missing, that the tooth is not also marked as exhibiting decay as a missing tooth cannot exhibit decay.

At step 1914, odontogram 1138 may be updated to reflect the received input, such as the marking of a tooth as missing or having decay. In particular, updated odontogram 1138 may comprise indicators corresponding to the application of tool items 1104 to the teeth depicted by odontogram 1138. In the illustrative embodiment, mobile device 114 may update odontogram 1138 to include indicators showing the application of some of tool items 1104 depicted in FIG. 11 to teeth as follows:
(a) the application of missing teeth tool 1140 may result in odontogram 1138 including missing tooth icon 1108;
(b) the application of the existing restoration tool may result in odontogram 1138 including existing restoration icon 1110;
(c) the application of the existing crowns tool may result in odontogram 1138 including existing crown icon 1112;
(d) the application of the existing implants tool may result in odontogram 1138 including existing implant icon 1114;
(e) the application of the mobility tool may result in odontogram 1138 including mobility icon 1118a and mobility icon 1118b;
(f) the application of the decay tool may result in odontogram 1138 including decay icon 1120 which may further correspond to the additional input received through the aforediscussed tooth form 1206;
(g) the application of the existing root canal tool may result in odontogram 1138 including existing root canal icon 1122;
(h) the application of the fractured crown tool may result in odontogram 1138 including fractured crown icon 1124;
(i) the application of the periapical lesion tool may result in odontogram 1138 including periapical lesion icon 1126;
(j) the application of the pockets tool (as depicted in FIG. 13) may result in odontogram 1138 including pockets icon 1134;
(k) the application of the furcations tool (as depicted in FIG. 13) may result in odontogram 1138 including furcations icon 1128;
(l) the application of the recession tool (as depicted in FIG. 13) may result in odontogram 1138 including recession icon 1130; and
(m) the application of the lack attached gingiva tool (as depicted in FIG. 13) may result in odontogram 1138 including lack attached gingival icon 1132;

Illustratively, indicators may be selected to be visually suggestive of the corresponding tool. For example, missing tooth icon 1108 is suggestive of the absence of a tooth, existing restoration icon 1110 is suggestive of an existing restoration, and existing implant icon 1114 is suggestive of the presence of an implant.

At step 1912, further user input may be received by mobile device 114.

If mobile device 114 determines that such further user input comprises a further application of the presently selected one of tool items 1104 (i.e. mobile device 114 has received further user input applying the tool per step 1916), odontogram 1138 may again be updated per step 1914. This further user input may comprise, for example, the user selecting another tooth or a tooth previously selected.

In some embodiments, one of tool items 1104 may be applied repeatedly to the same tooth. In some circumstances, subsequent applications may have no effect. Alternatively, applications of a tool may have the effect of toggling the application of the tool with respect to a particular tooth. For example, a first application of missing teeth tool 1140 may have the effect of replacing a normal tooth icon (such as normal tooth icon 1142) with missing tooth icon 1108 (and system 100 recording that such tooth is missing), a second application may have the effect of replacing missing tooth icon 1108 with a normal tooth icon (and system 100 recording that such tooth is not missing), a third application may have the effect of replacing the normal tooth icon with missing tooth icon 1108 (and system 100 recording that such tooth is missing), and so forth. In a further alternative, repeated applications of a tool may have the effect of cycling between multiple states (and eventually returning to a state wherein the tool is not applied to the tooth). For example, a single application of the mobility tool may result in mobility icon 1118a (and system 100 recording that such tooth has a mobility rating of “1”), whereas two applications of the mobility tool to the same tooth may result in mobility icon 1118b (and system 100 recording that such tooth has a mobility rating of “2”), and so forth until for some maximum number of applications a normal tooth icon is again displayed (and system 100 not recording any mobility rating for such tooth).

If mobile device 114 determines at step 1912 that such further user input is for mobile device 114 to present the previous form (i.e. step 1918), at step 1920, the previous form may be presented to the user, as previously described. This user input may comprise, for example, the user selecting previous form button 1136.

If mobile device 114 determines at step 1912 that such further user input is a user's selection of a different one of tool items 1104 (i.e. step step 1906), at step 1908, mobile device 114 may again determine whether there is a specific form associated with the newly selected one of tool items 1104. FIG. 13 is an illustrative embodiment wherein a specific form is so associated.

In particular, FIG. 13 corresponds to the situation wherein pockets tool 1304 is selected by a user (after the user first selects peridontics submenu 1106 in a prior step, not shown). Once selected, mobile device 114 determines that pockets form 1306 is associated with pockets tool 1304 and therefore presents pockets form 1306 at step 1910. User input comprising a user's selection of GUI elements of pockets form 1306 such as numeric keypad 1308 may be received by mobile device 114 at step 1916.

In this illustrative embodiment, previous tooth button 1310, and next tooth button 1312 are included in pockets form 1306 to provide an alternative method for applying a tool to a tooth. In particular, current tooth icon 1314 is an indicator of a currently selected tooth, a user's selection of a number on numeric keypad 1308 is received by mobile device 114 and used by mobile device 114 to update dental form 1102 to include an indicator such as pockets icon 1134, and previous tooth button 1310 and next tooth button 1312 permit a user, by selecting either of previous tooth button 1310 or next tooth button 1312, to select a different tooth as indicated by current tooth icon 1314.

In another illustrative embodiment, FIG. 14 corresponds to the situation wherein endodontics submenu 1404 is selected by a user. Similar to step 1908 and step 1910, selecting endodontics submenu 1404 may cause endodontics form 1402 to be presented. In this embodiment, endodontics form 1402 may comprise teeth icons 1406, test form 1408, teeth markers 1412, and done button 1410. A user may first select one of teeth markers 1412 to add an icon to teeth icons 1406 corresponding to the selected tooth. A user may next repeatedly input the results of various tests to the selected tooth (such as cold test, hot test, electric pulp test, percussion, palpation, and bite stick) into test form 1408. In an illustrative embodiment, the user may also input certain conclusions, such as that a root canal is needed for a particular tooth. A user's selection of done button 1410 may cause the previously presented GUI screen to again be presented.

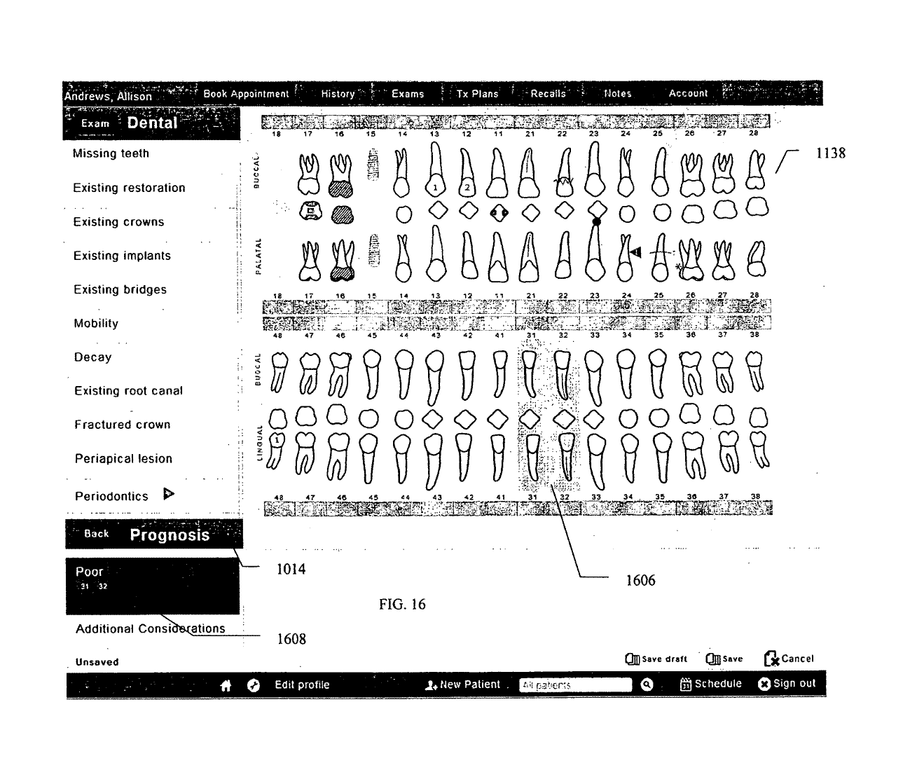

Finally, again with reference to FIG. 10, FIG. 16 and FIG. 18, the operation of system 100 upon a user's selection of the last exemplary form option may be described. In particular, if a user selects prognosis form option 1014 at step 1808, mobile device 114 may determine at step 1810 to present a form comprising odontogram 1138 and tools such as poor prognosis tool 1608, as depicted by FIG. 16. Application of poor prognosis tool 1608 to selected teeth may cause such teeth to have highlighting 1606, temporarily, to visually communicate to a user the application of the tool to the teeth. Selection of other exemplary form options at step 1808 such as diagnosis form option 1012 and exam notes form option 1016 may similarly result in the presentation of corresponding forms for receiving user input.

Having now described in detail the process of iterating through steps 1804, 1806, 1808, 1810 to allow a user to input the results of a dental examination input operation into system 100, the final steps corresponding to step 1814 and step 1816 are next described.

In particular, if mobile device 114 determines at step 1810 that it is to finish the operation based on the user input received at step 1808, at step 1814, mobile device 114 may compile and submit the user input received at each of step 1806 (potentially from multiple iterations of the above described cycle) to application server 102. At step 1816, mobile device 114 may further present a summary of such compiled and submitted input, as described in greater detail hereinbelow with reference to FIG. 17.

In particular, the summary may comprise general summary 1704 and odontogram 1138 that reflect the previously received user input. The summary may further comprise endodontics button 1706, that, if selected by the user, causes odontogram 1138 to be replaced with a summary of information inputted into endodontics form 1402. In an illustrative embodiment, there may also be share button 1710 for sharing the summary with another user (whether by email or through providing access to the summary through system 100), and previous examination summary button 1712 and next examination summary button 1714 for causing summaries of other dental examination input operations to be presented.

From the summary of the now completed dental examination input operation, a user may select history button 906 to return to patient summary 902. A new patient record item, analogous to exam item 926, may be displayed to correspond to this now completed dental examination input operation, as aforedescribed.

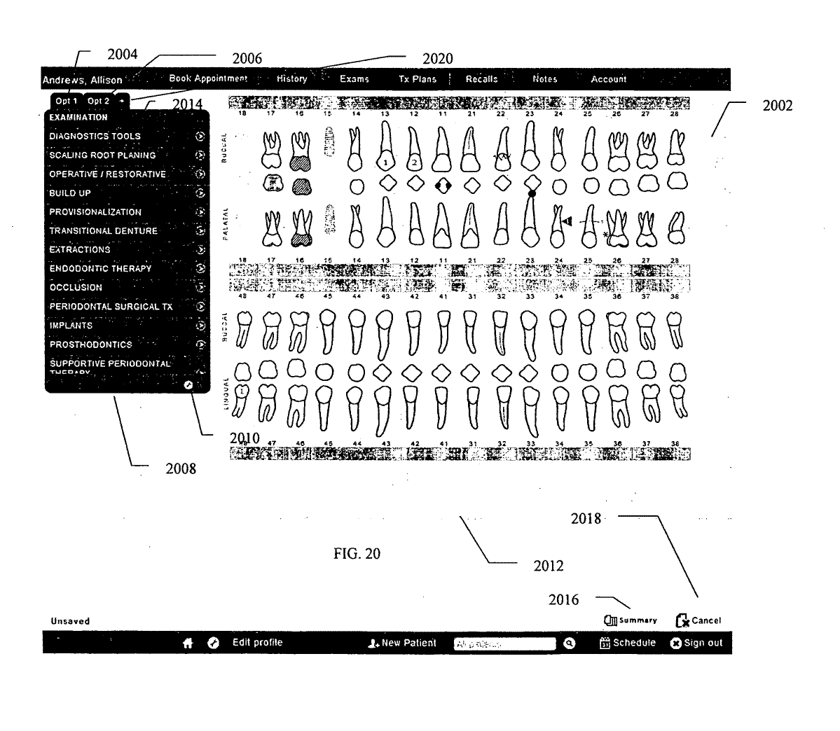

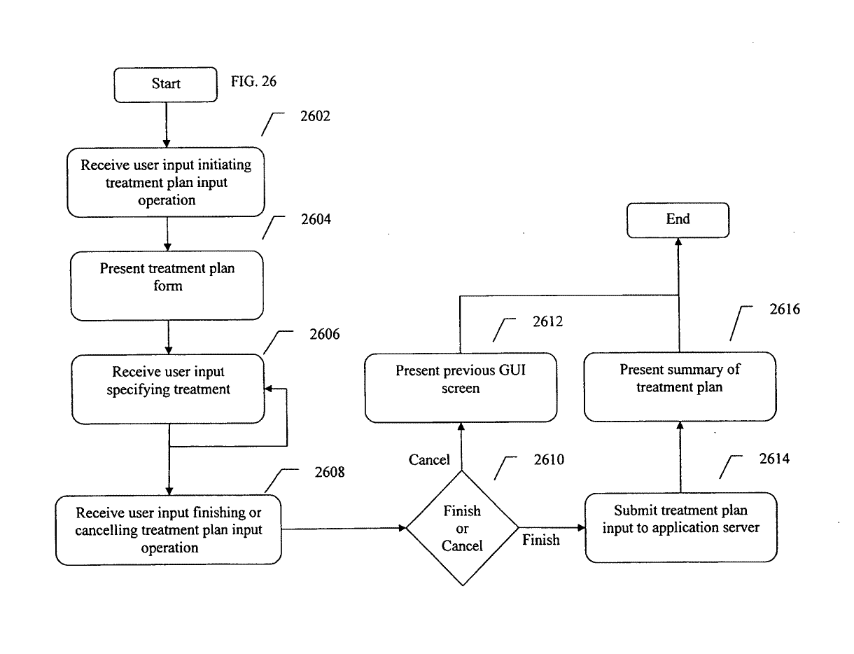

With reference to FIGS. 20-26, a treatment plan input operation is now described. FIGS. 20-25 are exemplary screenshots of GUI screens corresponding to a treatment plan input operation and FIG. 26 is a corresponding flow diagram depicting a treatment plan input operation. Generally speaking, this operation is for a user to input one or more possible treatment plans into system 100, and operates functionally in a similar fashion to the steps of the dental examination input operation.

At step 2602, mobile device 114 receives user input initiating a treatment plan input operation. In an embodiment of the present invention, this input may comprise a user selecting treatment plans button 910 to cause the aforedescribed options to be presented, and thereafter selecting a presented option of initiating a treatment plan input operation. The patient associated with this treatment plan input operation may already be known by system 100, as in this illustrative embodiment, or system 100 may be configured to query the user to determine the associated patient.

At step 2604, mobile device 114 presents treatment plan form 2012 to user, treatment plan form 2012 comprising treatment options 2008 (treatment options 2008 in turn comprising a plurality of submenus, such as diagnostics submenu 2106, scaling root planing submenu 2212, operative/restorative submenu 2304, build up submenu 2410, and provisionalization submenu 2506), option 1 tab 2004, option 2 tab 2006, new option button 2020, and customize button 2010 and odontogram 2002.

In the illustrative embodiment depicted by FIG. 20, a default set of pre-selected submenus is presented, each submenu corresponding to one or more specific types of pre-selected treatments (including diagnostic treatments) that are known to medical professionals skilled in the relevant art. Related types of treatments may be organized together and represented by submenus, and the text (or graphical label) of each submenu may correspond or describe the related types of treatments. For example, diagnostic treatments may be grouped together and represented by a submenu labelled “DIAGNOSTICS TOOLS”. In some embodiments, a submenu may correspond to a specific treatment, instead of a type of treatment.

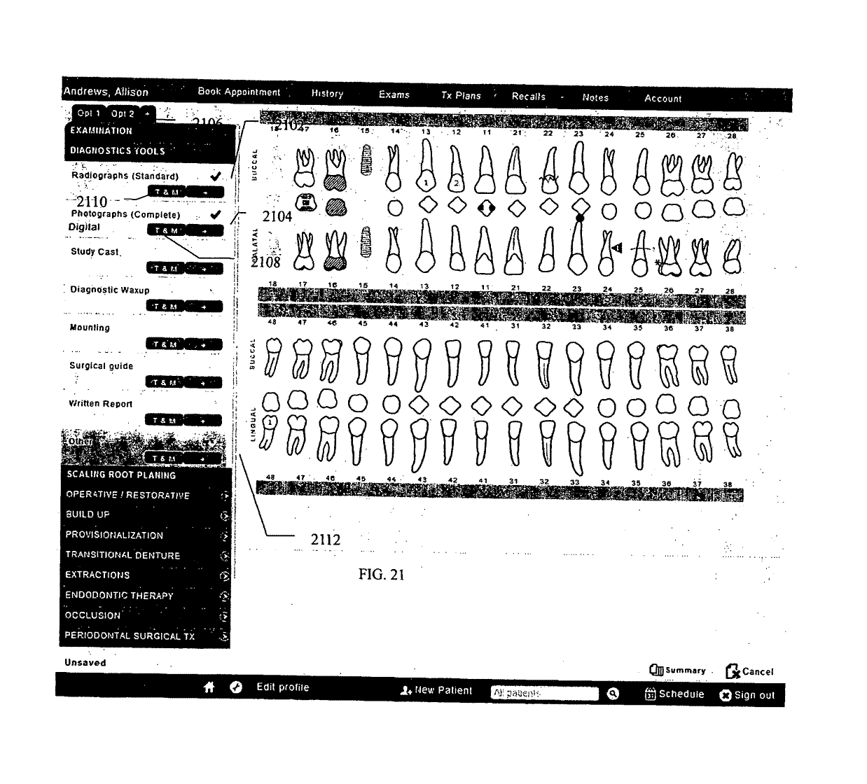

As described in greater detail herein, selection of a particular submenu may similarly provide access to a default set of pre-selected treatment tools that correspond to specific treatments (including diagnostic treatments) that may be given to a patient, each treatment tool having text (or a graphical label) corresponding to the specific treatment. Thus, for example with reference to FIG. 21, and as described in greater detail below, diagnostics submenu 2106 may provide access to one or more diagnostics tools 2112 including radiographs tool 2102 and photographs tool 2104 that correspond to giving a radiographic treatment or a photographic treatment to a patient, respectively.

In the illustrative embodiment, the ordering of the default set of pre-selected submenus and corresponding treatment tools is pre-selected. Indeed, more generally, according to some embodiments of the present embodiment, the selection, grouping, and ordering of the submenus and treatment tools may be a relevant aspect of system 100 and may be performed in view of a variety of considerations.

In particular, in one embodiment of the present invention, the submenus may be presented in an ordered sequence wherein the order of the submenus corresponds to the order in which the corresponding treatments or treatment types would be given to a patient. That is, if, for example, the submenus are presented as a list having an order, for some (or all or substantially all) of the submenus, such submenus may be presented in such order since the treatments or treatment types corresponding to such submenu would, in practice, be given to a patient by a medical professional in such order.

Similarly, in one embodiment of the present invention, the individual treatment tools corresponding to a submenu may be similarly presented in an ordered sequence wherein the order of the treatment tools corresponds to the order in which the corresponding treatments or treatment types would be given to a patient.

For example, with reference to figures described in greater detail herein, it may be standard dental practice to do the following treatments in the following order: (a) a post and core treatment, (b) a temporary filling, and (c) a crown. Thus, the submenus corresponding to each treatment—build up, provisionalization, and prosthodontics—may be presented in a corresponding order (as part of, for example, a larger list such as treatment options 2008).

As another example, it may be standard dental practice to do the following treatments in the following order: (a) an extraction, (b) an implant, and (c) a crown on implant. Thus, the submenus corresponding to each treatment—extractions, implants, and prosthodontics—may be presented in a corresponding order (as part of, for example, a larger list such as treatment options 2008).

As another example, it may be standard dental practice to do the following treatments in the following order: (a) a diagnostic waxup, (b) a surgical guide, and (c) an implant. Thus, the submenus (and in this example, the treatment tools) corresponding to each treatment—diagnostic tools, diagnostic waxup, surgical guide, and implants—may be presented in a corresponding order (as part of, for example, a larger list such as treatment options 2008).

As a last example, it may be standard dental practice to do the following treatments in the following order: (a) a filling, and (b) a root canal. Thus, the submenus corresponding to each treatment—operative/restorative and endodontic therapy—may be presented in a corresponding order (as part of, for example, a larger list such as treatment options 2008).

More generally, the selection, grouping, and ordering of submenus and treatment tools may be adapted to assist a medical professional in their design and inputting of a treatment plan, and may include an ordering of submenus and treatment tools that may not necessarily correspond to the order in which corresponding treatments and treatment types would be given to a patient.

For example, the selection, grouping, and ordering may also be adapted to more generally guide a medical professional through a workflow to assist their design and inputting of a treatment plan. That is, the selection, grouping, and ordering may have the effect, by virtue of such selection, grouping, and ordering, of at least any of the following:
(a) assisting a medical practitioner in his or her recall of specific treatments that may be appropriate;
(b) reflecting medical best practices in the types of tests or diagnostic treatments that should be conducted prior to other treatments;
(c) reflecting medical best practices in the types of follow-up treatments (including post-operative examinations) that should be conducted subsequent to other treatments;
(d) more generally, reflecting dependencies and relationship between treatments, including treatments that are, in relation to one another, mutually exclusive, necessarily sequentially, and necessarily joint;
(e) excluding or reducing the use of obsolete or ineffectual treatments; and
(f) reducing the time required for a medical practitioner to input a treatment plan.

For example, in the illustrative embodiment depicted by FIG. 20, diagnostics submenu 2106 may be listed towards the top of treatment options 2008 as it may be useful when designing a treatment plan for a patient, generally speaking, to consider what diagnostic treatments should be done earlier rather than later in the process. Similarly, build up submenu 2410 may be presented above operative/restorative submenu 2304 if build up treatments are generally conducted prior to, or as a precondition, to operative/restorative treatments.

The organization of selected treatments into submenus, and the subsequent ordering thereof, as depicted by FIGS. 20-25, may therefore be a useful aspect of this illustrative embodiment of the present embodiment.

At step 2606, mobile device 114 may receive, one or more times, user input specifying a particular treatment. Different illustrative embodiments of this step are described below in greater detail with reference to FIGS. 21-25.

At step 2608, mobile device 114 receives user input to finish the treatment plan input operation or to cancel the treatment plan input operation. In the illustrative embodiment, user input to finish the treatment plan input operation may comprise a user's selection of summary button 2016 and user input to cancel the treatment plan input operation may comprise a user's selection of cancel button 2018.

At step 2610, mobile device 114 determines, on the basis of what user input was received at step 2608, whether to cancel the treatment plan input operation or finish the operation. If mobile device 114 determines it is to cancel the treatment input operation, at step 2612, mobile device 114 may present the previous GUI screen displayed prior to commencing the treatment plan input operation. For example, if the operation was initiated while patient summary 902 was displayed, mobile device 114 may again present patient summary 902. If mobile device 114 determines it is to finish the operation, at step 2614, mobile device 114 may compile and submit the user input received at step 2606 to application server 102. At step 2616, mobile device 114 may further present a summary of such compiled and submitted input, as described in greater detail hereinbelow.

As noted above, different illustrative embodiments of step 2606 are now described in greater detail with reference to FIGS. 21-25.

FIG. 21 depicts, among other things, an expanded diagnostics submenu 2106 wherein diagnostics tools 2112 (corresponding to various diagnostic treatments) are presented, such as radiographs tool 2102 and photographs tool 2104. Receiving user input specifying a treatment at step 2606 thus comprises for this illustrative embodiment the user selecting diagnostics submenu 2106 (in order to cause it to expand to display diagnostics tools 2112) and selecting one or more of diagnostics tools 2112. In the depicted example, radiographs tool 2102 and photographs tool 2104 have both been selected (as indicated by the corresponding checkmarks), thus corresponding to the user of system 100 intending to include such diagnostic treatments in the treatment plan for the patient in question (in this case again the exemplary patient Allison Andrews).

In this example, the treatments do not correspond to a specific tooth of the patient, and accordingly, there is no interaction with odontogram 2002 required. Instead, each of diagnostics tools 2112 operate as toggles to include or remove a particular diagnostic treatment in the overall treatment plan. In some embodiments, it may be useful to provide further details with regard to each treatment. For this purpose each of diagnostics tools 2112 may comprise a type and materials button such as type and materials button 2108 and type and materials button 2110. These buttons operate so that, if selected by the user, mobile device 114 presents a further form to the user (potentially customized to the corresponding tool) for receiving further user input specifying additional details of the corresponding treatment. Once received, these inputted details may be presented to the user. In the illustrative example, radiographs tool 2102 includes the text notation that it is to be of a “standard” type and photographs tool 2104 includes the text notation that it is to be of a “complete” type and using “digital” materials.

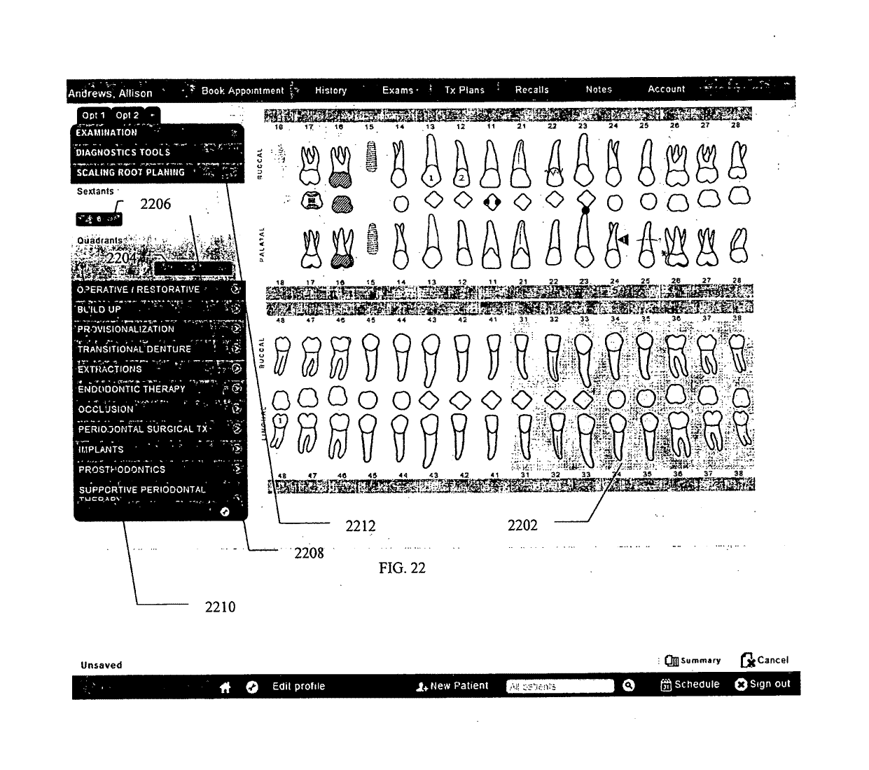

FIG. 22 depicts, among other things, an expanded scaling root planing submenu 2212. In contrast to diagnostics submenu 2106 that, when expanded, resulted in the display of related but different diagnostics tools 2112 such as radiographs tool 2102 and photographs tool 2104, expanding scaling root planing submenu 2212 only results in the display of sextant tool 2208 and quadrant tool 2210, tools differing only in the scope of their intended application (i.e. to a sextant and quadrant of a patient's mouth, respectively).

In this example, as the treatment corresponding to each of sextant tool 2208 and quadrant tool 2210 may be applied to all or a portion of a patient's mouth, there may be interaction with odontogram 2002 in order to specify the parameters of the treatment. In the illustrative example, a user may first select one of sextant tool 2208 or quadrant tool 2210, then select one or more regions on odontogram 2002, each selection having the meaning of proposing a scaling root planing treatment for the corresponding region. In the illustrative example, sextant button 2206 is depicted within sextant tool 2208 to indicate that such a treatment has been inputted. Similarly, quadrant button 2204 is depicted within quadrant tool 2210 to indicate that such a treatment has been inputted (this treatment is further emphasized, temporarily, by the inclusion of highlighting 2202). Additional purposes may also be served by quadrant button 2204 and sextant button 2206. First, these buttons may operate to provide a mechanism for a user to remove this treatment from the treatment plan, in particular, by selecting the button. Second, these buttons may also be scaled and positioned within sextant tool 2208 or quadrant tool 2210 to provide a visual indicator of the regions of the mouth each tool has been applied to. For example, quadrant button 2204 may be located in the lower right quadrant of quadrant tool 2210 to correspond to the lower right position of the selected region (as indicated by highlighting 2202).

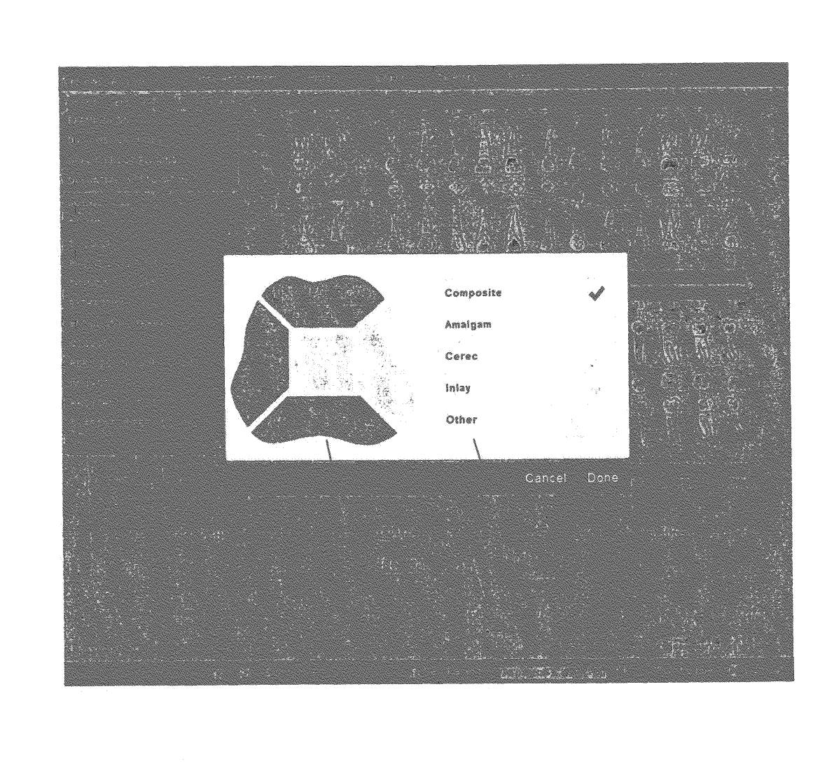

FIG. 23 depicts, among other things, an expanded operative/restorative submenu 2304 and operative/restorative tool form 2314. In contrast to both diagnostics submenu 2106 and scaling root planing submenu 2212, operative/restorative submenu 2304, when expanded, results in the display of only caries tool 2316 (corresponding to an operative/restorative treatment for caries).

In this example, as treatment of caries applies to a single tooth, there may again be interaction with odontogram 2002 in order to specify the details of the treatment. In the illustrative example, a user may first select caries tool 2316 (or it may be immediately pre-selected once operative/restorative submenu 2304 is expanded) then select a single tooth depicted by odontogram 2002, thus having the meaning of proposing such treatment for that tooth. In the illustrative example, caries button 2302 is depicted within caries tool 2316 to indicate that such a treatment has been inputted (for tooth 42, as indicated by the text displayed on caries button 2302). FIG. 23 further depicts operative/restorative tool form 2314 that may be presented immediately to a user upon a user's application of caries tool 2316 to a particular tooth. Operative/restorative tool form 2314 may comprise tooth form 2310, materials form 2312, cancel button 2308, and done button 2306. Similar to the purpose of the aforedescribed form presented further to selection of a types and material button such as type and materials button 2108, operative/restorative tool form 2314 provides means for a user to specify additional details related to the treatment corresponding to caries tool 2316. In the illustrative case, this includes details such as the portions of a tooth that require restoration, and what material is intended to be used. A user's selection of done button 2306 completes the step of receiving user input specifying a particular treatment; a user's selection of cancel button 2308 cancels this step and permits the user to specify another treatment.

As for sextant tool 2208 and quadrant tool 2210 (but not diagnostics tools 2112), caries tool 2316 may be repeatedly applied to different regions (i.e. teeth). Moreover, for this illustrative embodiment, the aforediscussed aspect of odontogram 2002 potentially including indicators corresponding to the findings of a dental examination input operation (as such operation was previously described), may be useful. For example, as decay icon 2318 may be included in odontogram 2002 indicating the presence of decay on the corresponding tooth of the patient, this information may be useful to the user in deciding to apply caries tool 2316 to the corresponding tooth to plan for treating the previously identified decay. More generally, by presenting odontogram 2002 that may include the findings of a dental examination input operation, a user may again be assisted in his or her design of a treatment plan.

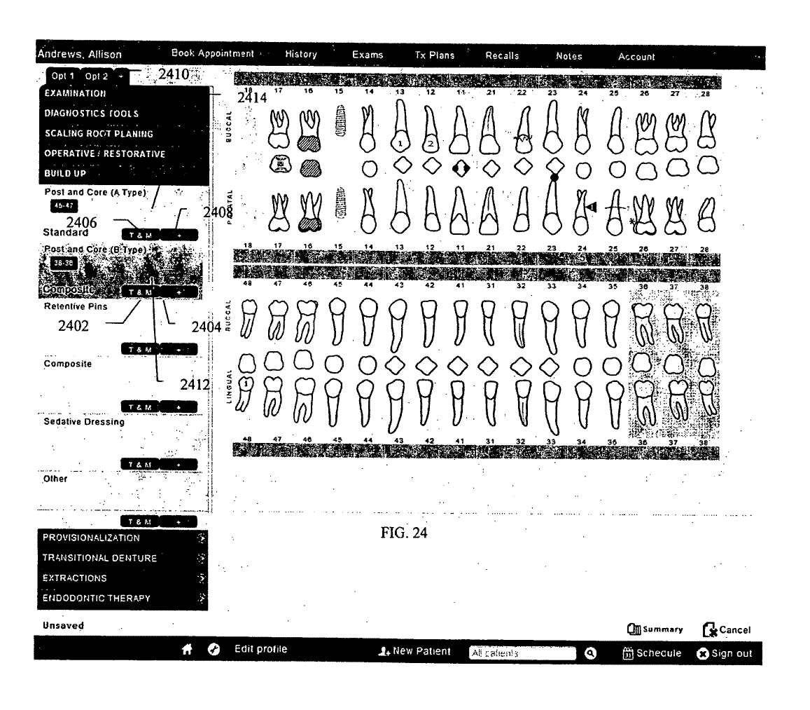

FIG. 24 depicts, among other things, an expanded build up submenu 2410 that, similar to diagnostics submenu 2106, corresponds to a number of related, but different treatments.

With regard to post and core treatments corresponding to post and core tool 2412 and post and core tool 2414, FIG. 24 is depicted in order to exemplify the use and potential purpose of new tool button 2408 and new tool button 2404. In particular, in some circumstances, a user may desire to input multiple treatments of the same type (such as post and core), but with different parameters. Accordingly, if a user selects new tool button 2408 corresponding to post and core tool 2414, a new post and core tool is inserted under build up submenu 2410. Thus, FIG. 24 depicts circumstances wherein new tool button 2408 has been already selected once, resulting in the second post and core tool 2412 that is depicted, and both type and material button 2406 and type and material button 2402 have been already selected by the user to further specify different details for each tool, namely, “A Type” using “Standard” materials for post and core tool 2414, and “B Type using “Composite” materials for post and core tool 2412. Additional tools may be further inserted by selecting either of new tool button 2408 and new tool button 2404. Thus, in the illustrative embodiment depicted by FIG. 24, the user has inputted that certain teeth are to be given a post and core treatment of “A Type” with “Standard” materials, and certain other teeth are to be given a post and core treatment of “B Type” with “Composite” materials.

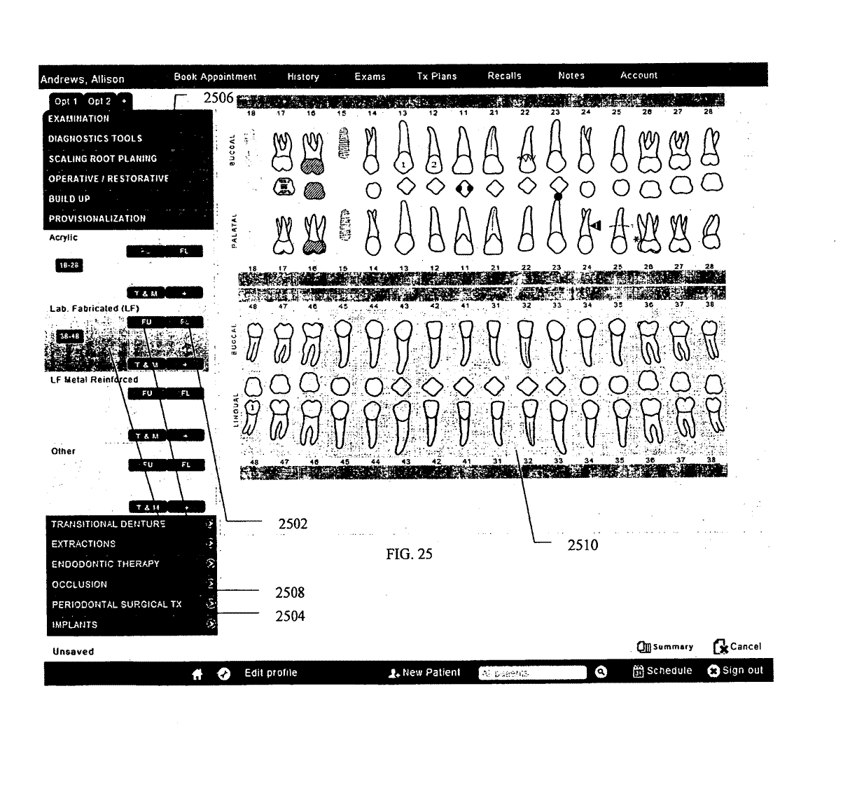

FIG. 25 depicts, among other things, an expanded provisionalization submenu 2506 that, similar to build up submenu 2410, corresponds to a number of related, but different, treatments. Moreover, the depicted tools, including lab fabricated tool 2504, operate in much the same fashion as what has already been described. Additionally, lab fabricated tool 2504 includes full upper button 2508 and full lower button 2502, these buttons having the purpose of allowing a user to select them and in so doing, apply lab fabricated tool 2504 to the whole of the upper or lower portions of the mouth, respectively. In the illustrative embodiment, full lower button 2502 has been selected, corresponding to highlighting 2510.

As noted above, FIGS. 21-25, as described in detail above, are illustrative embodiments of step 2606 comprising mobile device 114 receiving user input specifying a treatment. Together, this received input indicates a treatment plan that may, again as described above, be submitted to application server 102 and stored for future review, among other things.

Returning to FIG. 20, option 1 tab 2004, option 2 tab 2006, and new option button 2020 may jointly operate to enable a user to create one or more alternative treatment plans. By selecting new option button 2020, additional option tabs may be added, option 2 tab 2006 in the depicted embodiment indicating a previous selection of new option button 2020 by the user. Once created, a user may toggle between option 1 tab 2004 and option 2 tab 2006 by selecting either of option 1 tab 2004 and option 2 tab 2006.

User input specifying treatments (as described above) may therefore be associated with the particular option currently selected when such user input is received. A user may thus create, in turn or concurrently, multiple alternative treatment plans that may comprise different treatments and treatment characteristics, for example, for the purpose of assisting a patient with deciding which of multiple treatment plan alternatives to undergo on the basis of considerations such as cost and expected recovery time.

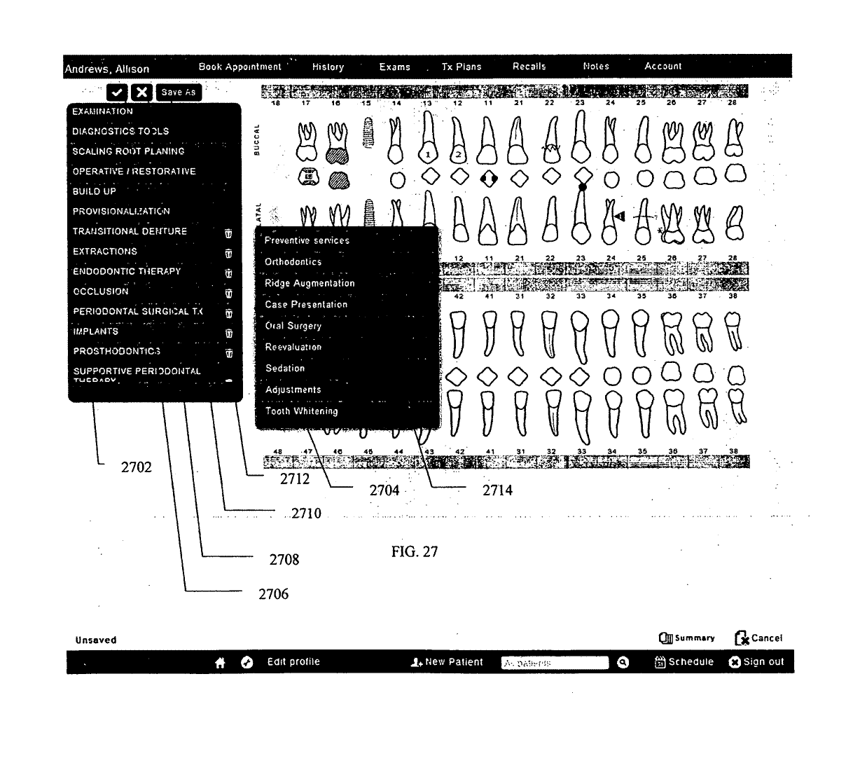

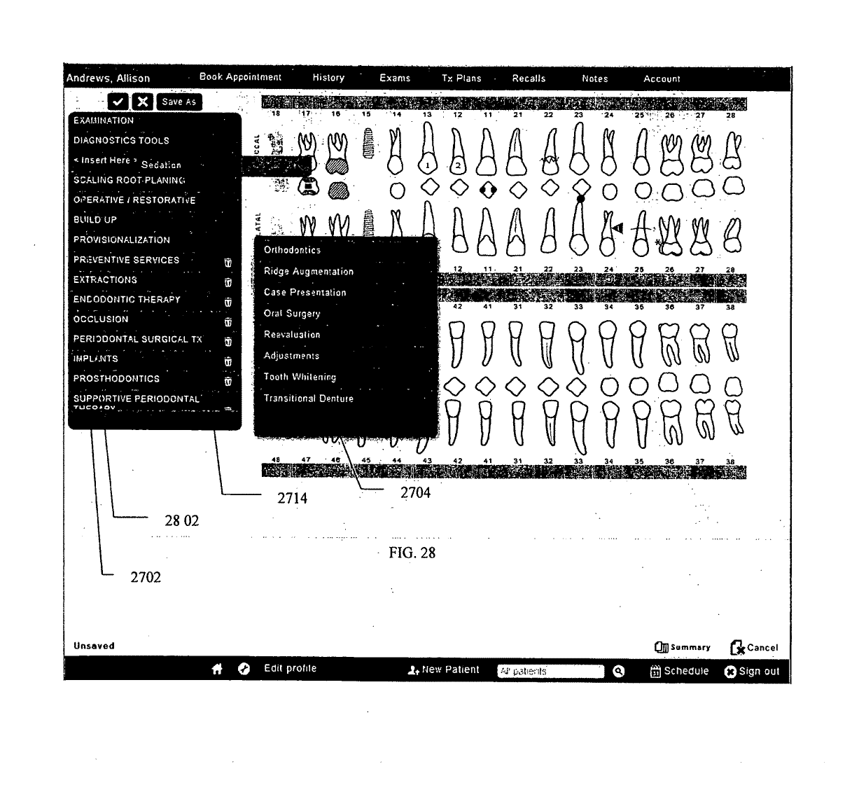

FIG. 27 and FIG. 28 are exemplary screenshots of GUI screens corresponding to a further feature associated with a treatment plan input operation. In particular, a user's selection of customize button 2010 may permit a user to customize the available submenus by causing mobile device 114 to present active submenus list 2702 and inactive submenus list 2704 to a user, together with save button 2706, cancel button 2708, and save as button 2710.

A user may drag and drop submenus from inactive submenus list 2704 into active submenus list 2702, at any position of the list. For example, FIG. 28 depicts sedation submenu 2714 in the process of being dragged and dropped into insert slot 2802 of active submenus list 2702 from inactive submenus list 2704. A user's selection of an inactivate button corresponding to a submenu, such as inactivate button 2712 may have the reverse effect of moving the submenu from active submenus list 2702 to inactive submenus list 2704, or otherwise deleting the submenu from active submenus list 2702. Once a user has sufficiently customized active submenus list 2702 for his or her particular needs by dragging and dropping one or more submenus, or inactivating one or more submenus, the user may select save button 2706 to save this configuration and return to the previous GUI screen displayed prior to the user's selection of customize button 2010 wherein, for example, treatment options 2008 have been updated to correspond to customized active submenus list 2702. Alternatively, a user may select cancel button 2708 to similarly return to the previous GUI screen displayed prior to the user's selection of customize button 2010 wherein, for example, treatment options 2008 have not been updated to correspond to customized active submenus list 2702.

While system 100 may present, as discussed above, a default pre-selected set of treatment options organized into submenus, the customization feature described immediately above with reference to FIG. 27 and FIG. 28 may be used to customize this default pre-selected set. In particular, since the universe of treatment options available to medical professionals may be quite large, organizing all such treatment options into submenus, and presenting all submenus to a user, may not be user friendly. By organizing, for example, more common treatments into submenus, some users may be presented with, by default, an improved user experience. The aforedescribed customization feature nevertheless permits users to include less common treatments into treatment plans. Moreover, as different users may have different preferences, potentially in part due to differences in the nature of a user's medical practice, save as button 2710 may be provided so that, if selected, a user may save customized active submenus list 2702 as a template for future treatment plan input operations. If this is done, a user's selection of treatment plans button 910 may result in a further option of initiating a treatment plan input operation using a saved template corresponding to active submenus list 2702 instead of the default pre-selected set of treatment options organized into submenus.

In another embodiment of the present invention, system 100 may be configured to provide further assistance in the design of a treatment plan. In particular, system 100 may be configured to process the input of a dental examination input operation and, based on this input, provide particular recommendations or options in respect of a patient's treatment plan. For example, if, through a dental examination input operation, a tooth is indicated has exhibiting decay, system 100 may be configured to recommend caries treatment for the corresponding tooth as part of a treatment plan input operation.

In other embodiments, system 100 may be configured to customize treatment options 2008 (or submenus thereof), again on the basis of the input of a dental examination input operation. For example, system 100 may be configured to include sedation submenu 2714 in treatment options 2008 for a particular user if system 100 determines a patient is likely to require sedation. Similarly, system 100 may be configured to remove certain submenus (or treatments). For example, system 100 may be configured to remove operative/restorative submenu 2304 if system 100 determines a patient is unlikely to require treatments of such type, for example, if no decay has been inputted for any tooth of this patient. This configuration may also be performed in realtime in response to other input, including the treatments that have already been specified for a particular patient. For example, if system 100 receives user input (as part of a treatment plan input operation) indicating that a particular first treatment should be given to a patient (e.g. an implant), system 100 may be configured to present a new submenu or treatment tool to the user that corresponds to a different treatment or treatment type that the medical practitioner should also consider giving to the patient in view of the first treatment (e.g. an implant treatment may trigger the presentation of an extraction submenu or tool since it may be likely that an extraction is required if an implant is to be given)

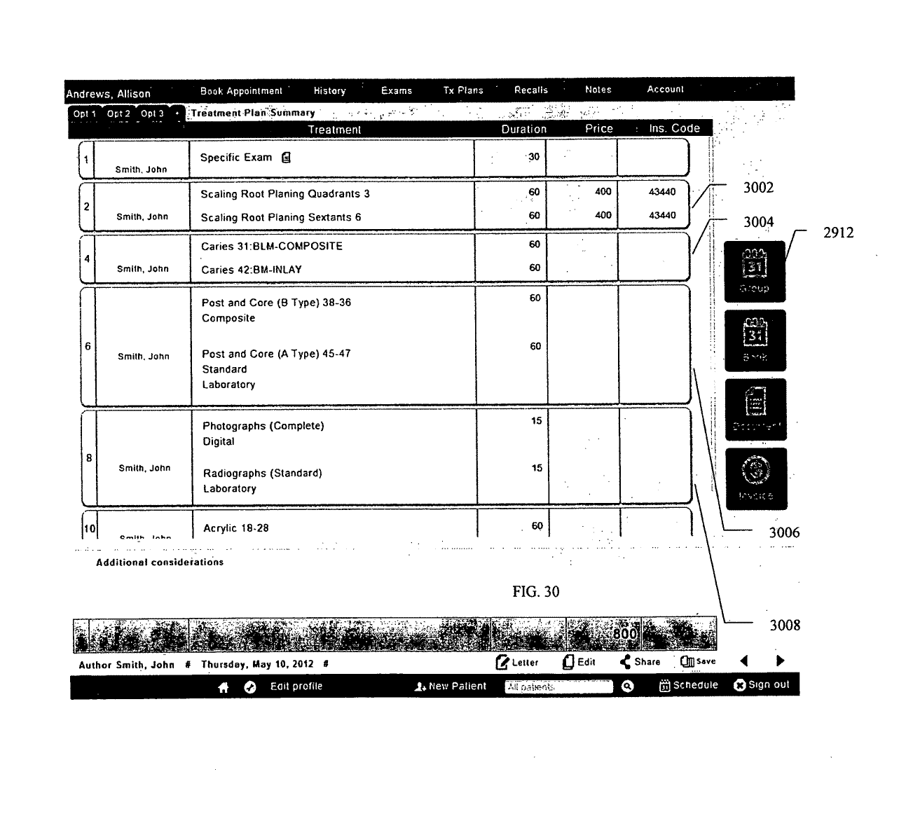

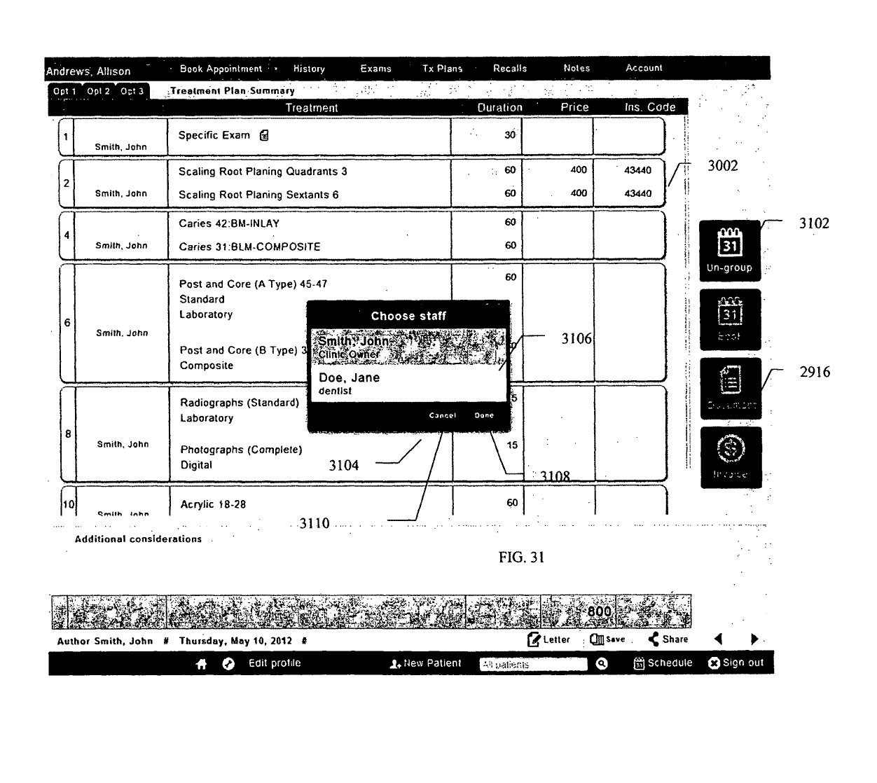

Returning to FIG. 26, mobile device 114 was previously described as presenting a summary to a user, at step 2616, of the compiled and submitted input to the treatment plan input operation. This summary is now described in greater detail with reference to FIG. 29, FIG. 30, and FIG. 31.

FIG. 29 comprises, among other things, treatment plan summary 2920 that in turn comprises:
(a) options tabs such as option 1 tab 2902 and option 2 tab 2904 for toggling between alternative treatment plan options;
(b) a set of buttons including group button 2912, schedule button 2914, document button 2916, and invoice button 2918;
(c) For each options tab (e.g. option 1 tab 2902 and option 2 tab 2904), treatment list 2910 and additional considerations field 2924; and
(d) additional buttons letter button 2928 (for the purpose of printing information to give, for example, to a patient), edit button 2926 (for the purpose of enabling a user to initiate an edit treatment plan operation substantially similar to the treatment plan input operation described above), share button 2932 (for sharing this treatment plan with another user, whether by email or through providing access and/or joint modification rights to the summary through system 100 to another user having a user account with system 100), and navigation buttons 2930 (for navigating among previously inputted treatment plans).

In the illustrative embodiment, a user's selection of option 1 tab 2902 causes a summary of the treatment plan corresponding to option 1 tab 2004 to be displayed (and similarly for option 2 tab 2904 and option 2 tab 2006).

As option 1 tab 2902 is selected in the embodiment depicted by FIG. 29, treatment list 2910 is presented to a user showing the treatments previously inputted in association with option 1 tab 2004 at step 2606. In the present example, these treatments include first scaling treatment 2906 and second scaling treatment 2908 corresponding, respectively, to the application of sextant tool 2208 and quadrant tool 2210 as described above in respect of FIG. 22.

System 100 may be configured to populate the duration, price, and insurance code fields of treatments. For example, for second scaling treatment 2908, the system has prepopulated duration field 2938, price field 2934, and insurance code field 2936 on the basis of knowledge that system 100 has and the details about second scaling treatment 2908 inputted during the treatment plan input operation. For example, system 100 may know that a radiograph of a “Standard” type has a particular duration, price, and insurance code, but that radiographs of a “Comprehensive” type have a longer duration, and also a different price and insurance code. In some embodiments these fields may still be further modified by user even after system 100 has populated the fields. In still other embodiments, system 100 may be configured to learn the correspondence between treatments and the appropriate field values, such as by storing in database server 104 values previously entered by a user. While in the illustrative embodiment only the fields “duration”, “price”, and “insurance code” are depicted, in other embodiments, other fields may also be present, such as a list of clinic staff members qualified to provide the treatment for the purpose of allowing a user to select a staff member to perform the treatment.

Treatments depicted in treatment list 2910 may be reordered by dragging and dropping the corresponding row. For example, it may be possible to reorder first scaling treatment 2906 and second scaling treatment 2908 so that second scaling treatment 2908 is above first scaling treatment 2906. This may be done in circumstances where the order of the treatment list is considered relevant to a user, such as if multiple treatments are to be done in a particular order as discussed in greater detail below.

There may also be additional considerations field 2924 provided in association with option 1 tab 2902. A user may optionally input notes into this field to be saved by system 100 together with the treatment plan, and presented together therewith if the treatment plan is again presented.

In the illustrative embodiment, group button 2912 is for grouping two treatments together, such as first scaling treatment 2906 and second scaling treatment 2908, for the purpose of scheduling the treatments together as a single appointment through the process described below. With reference also to FIG. 30, grouped scaling treatments 3002 may be created by a user first selecting both first scaling treatment 2906 and second scaling treatment 2908, then selecting group button 2912. Additional illustrative grouped treatments are depicted in FIG. 30, namely, grouped caries treatments 3004, grouped post and core treatments 3006, and grouped diagnostics treatments 3008. There is no requirement that grouped treatments are similar in type although system 100 may operate to evaluate whether grouped treatments are properly grouped, and if not, warn the user or otherwise perform certain actions in response to this determination. For example, system 100 may know that a post and core treatment and a caries treatment cannot be performed during the same appointment, for example, if there must be a recovery time of several days between them, and warn a user if such treatments are grouped. With reference to FIG. 31, grouped treatments (such as grouped scaling treatments 3002) may be ungrouped in a similar fashion, namely, by selecting the grouped treatments and selecting ungroup button 3102 (that mobile device 114 may cause to replace group button 2912 upon a user's selection of grouped treatments).

This grouping feature, together with the aforedescribed reordering feature, may permit treatment list 2910 to be used as an organization tool. For example, by grouping treatments that are to be done together into treatment groups and by reordering such treatment groups into their sequential order, treatment list 2910 may be used to design and organize a patient's overall treatment plan that comprises a plurality of treatments.

Invoice button 2918 is for the purpose of initiating an invoice generating operation. A user may select one or more treatments, then select invoice button 2918 to generate an invoice. Accounting and billing functionality more generally may be integrated into system 100, or alternatively, handled through a separate system that may or may not be in communication with system 100. An icon (not shown) may be associated with treatments that have been invoiced, in a fashion similar to documented icon 2922.

Document button 2916 is for the purpose of initiating a progress note input operation, as will be described in greater detail below.

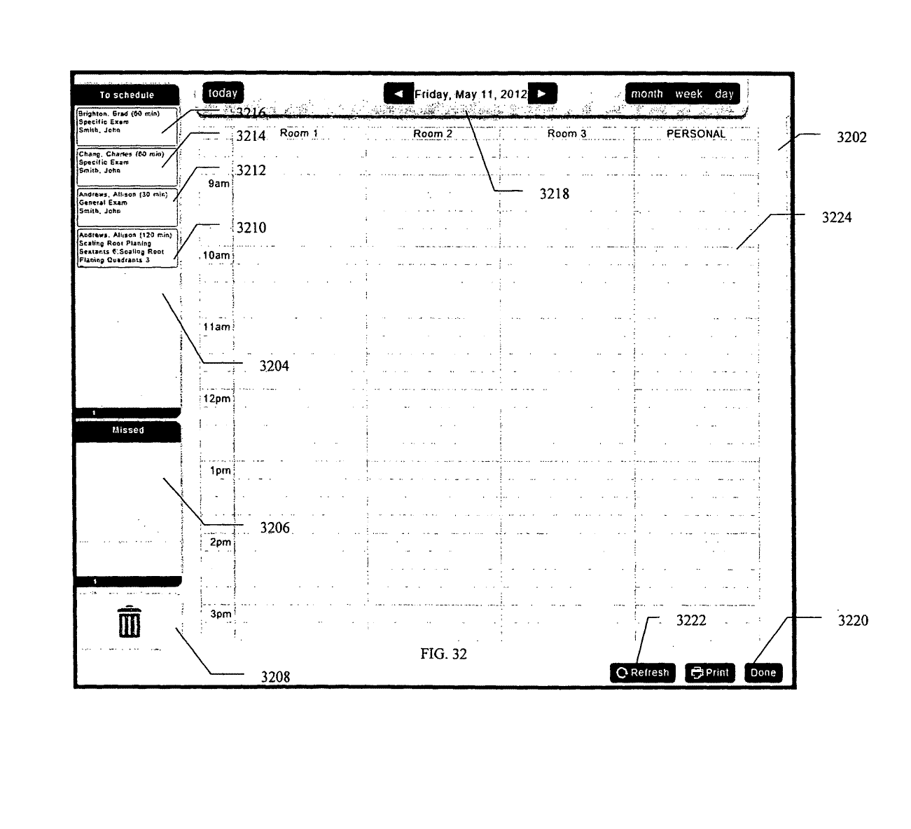

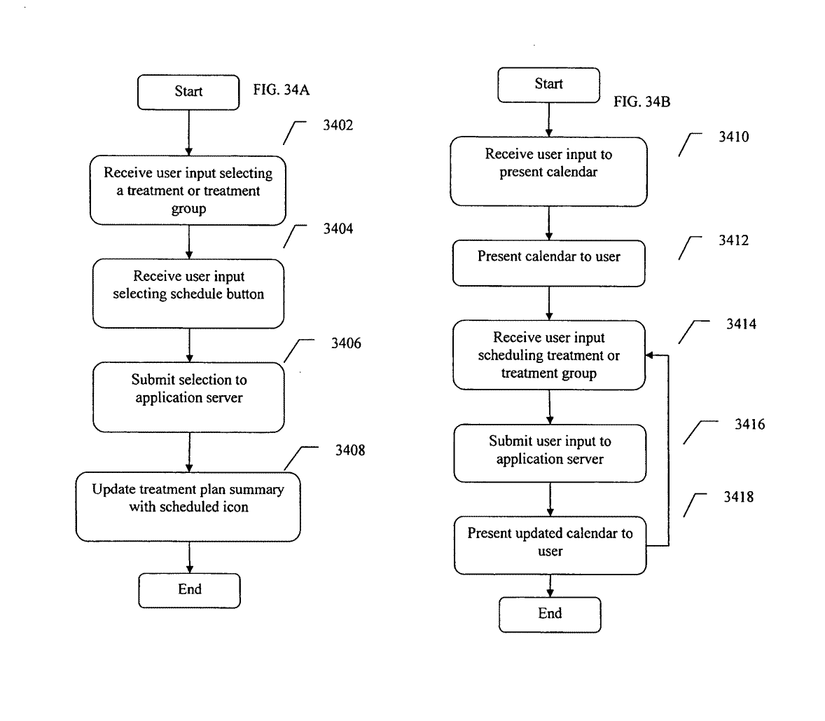

The operation of schedule button 2914 to create an appointment is now described in greater detail with reference to FIG. 32 and FIG. 34A. At step 3402, mobile device 114 may receive user input selecting a treatment or treatment group, such as grouped scaling treatments 3002. This user input may comprise a user selecting grouped scaling treatments 3002, from treatment list 2910. At step 3404, mobile device 114 may receive user input selecting schedule button 2914 corresponding to a user's selection of schedule button 2914. In some embodiments (not depicted in FIG. 34A) mobile device 114 may next present staff selection form 3104 to the user to allow the user to select a staff member from staff list 3106 to associate with this appointment. Similar to other buttons described herein, selecting done button 3108 or cancel button 3110 respectively causes the operation to continue or to cancel. At step 3406, mobile device 114 submits to application server 102 an indication of this received user input (including the associated staff member in embodiments where staff selection form 3104 was presented). At step 3408, mobile device 114 may update treatments that have been so scheduled to have an icon (not shown) associated therewith, in a fashion similar to documented icon 2922.

The steps described immediately above may not provide any mechanism for specifying a date and time for an appointment. In an illustrative embodiment of the present invention, the above steps merely cause mobile device 114 to submit to application server 102 an indication of an appointment that is to be scheduled, together, in some circumstances, with the identity of the staff member that the appointment is to be scheduled with.

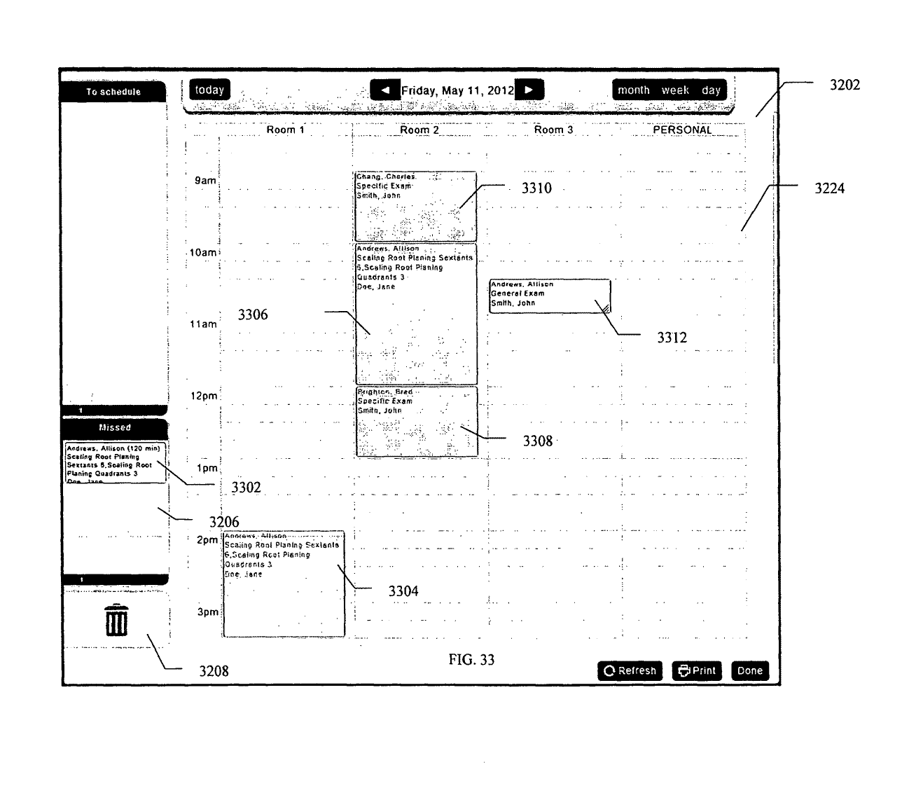

With reference to FIG. 34B, FIG. 32, and FIG. 33, a separate sequence of steps may be undertaken to complete the scheduling of an appointment. In particular, at step 3410, mobile device 114 may receive user input to present calendar 3202. This user input may comprise a user's selection of schedule button 332 (see FIG. 3); or, in an alternative embodiment, this process may be automatically triggered by the same user input received by mobile device 114 at step 3404.

At step 3412, mobile device 114 may present calendar 3202 comprising pending bin 3204, missed bin 3206, trash icon 3208, calendar body 3224, date navigation toolbar 3218, refresh button 3222, and done button 3220.

Separate from this operation, calendar 3202 and calendar body 3224 may be configurable by a user through a suitable GUI screen, such as one presented in response to a user's selection of edit configuration button 322 (see FIG. 3). For example, the number of rooms and the hours during which the rooms are available may be configurable to correspond to the office hours of a corresponding medical clinic.

As depicted by illustrative FIG. 32, pending bin 3204 may be populated with patient appointments 3210, 3212, 3214, 3216 that require scheduling, including in particular, patient appointment 3210 that corresponds to the exemplary treatment used to describe the effect of a user selecting schedule button 2914, namely, grouped scaling treatments 3002. That is, subsequent to completing steps 3402, 3404, 3406, 3408 in association with grouped scaling treatments 3002, system 100 may be configured so that patient appointment 3210 is included in pending bin 3204 when calendar 3202 is presented to the user.

At step 3414, mobile device 114 may receive user input scheduling a particular appointment, that is, one of patient appointments 3210, 3212, 3214, 3216 corresponding to a treatment or treatment group. This user input may illustratively comprise the user dragging and dropping patient appointment 3210 onto calendar body 3224 in a position, for example, corresponding to “Room 2” from “10:00 am” to “12:00 pm”.

Once this user input is received, mobile device 114 may proceed, at step 3416, to submit the received scheduling details to application server 102 and further, at step 3418, present updated calendar 3202 wherein patient appointment 3210 is removed from pending bin 3204 and a corresponding calendar item is placed onto calendar body 3224 (as described in more detail below).

With reference to both FIG. 32 and FIG. 33, pending bin 3204 and the aforedescribed scheduling operations may have the purpose of allowing users of system 100 to schedule patient appointments. For example, a first user corresponding to a first user account of system 100 (such as a medical professional) may complete the steps depicted by FIG. 34A using a first client device, whereas a second user corresponding to a second user account of system 100 (such as a medical receptionist) may complete the steps depicted by FIG. 34B using a second client device. In such circumstances, it may be necessarily to configure system 100 so that users logged in with credentials corresponding to the first and second user accounts share the ability to access and act upon the same calendar items, among other things.

In practice, this illustrative embodiment may be used in circumstances such as wherein a patient and medical professional decide upon a treatment plan, the medical professional accesses system 100 to “add” a corresponding appointment to pending bin 3204, and the receptionist is therefore made aware of and able to schedule this appointment with the patient without any further interaction with the medical professional. In alternative embodiments of the present invention, a single user (such as a medical professional) may complete both operations. In still further alternative embodiments of the present invention, this aforedescribed operation may be streamlined into a single operation wherein, upon a user's selection of schedule button 2914, they are immediately presented with a suitable GUI for scheduling the corresponding treatment.

A further aspect of calendar 3202, namely, missed bin 3206, may also be described with reference to FIG. 33. In particular, a user may drag and drop a scheduled appointment such as patient appointment 3312 from calendar body 3224 into missed bin 3206. This may be done, for example, if the patient has missed their appointment and it is necessary to reschedule this appointment with the patient. By dragging and dropping the scheduled appointment into missed bin 3206, system 100 may be configured to record this missed appointment for the purpose of displaying a notation in patient summary 902 (see FIG. 9). The appearance of the missed appointment in calendar body 3224 may also be modified by greying it out. System 100 may also be configured to populate missed bin 3206 with the missed treatment so that it may be rescheduled through an operation analogous to that described above. For example, FIG. 33 may be considered to depict as follows, with reference to FIG. 32:
(a) patient appointment 3216 was first scheduled for room 2, 12:00 pm to 1:00 pm on May 11, 2012, but this appointment was missed (missed patient appointment 3308), and subsequently rescheduled to a different day not depicted in FIG. 33;
(b) patient appointment 3214 was scheduled for room 2, 9:00 am to 10:00 am on May 11, 2012, but this appointment was also missed (missed patient appointment 3310) and subsequently rescheduled to a different day not depicted in FIG. 33;
(c) patient appointment 3212 is scheduled for room 3, 10:30 am to 11:00 am on May 11, 2012 (patient appointment 3312);
(d) patient appointment 3210 was originally scheduled for room 2, 10:00 am to 12:00 pm on May 11, 2012, this first appointment was missed (missed patient appointment 3306) and rescheduled to room 1, 2:00 pm to 4:00 pm on May 11, 2012, this second appointment was also missed (missed patient appointment 3304), and missed bin 3206 is currently populated with patient appointment 3302 that requires scheduling.

Although this illustrative embodiment of the present invention depicts the use of two bins, namely, pending bin 3204 and missed bin 3206, in other embodiments of the present invention a different number of bins may be present. For example, a third bin may be used for appointments that are rescheduled by the medical professional, and a fourth bin may be used for appointments that the patient did not attend without providing notice (distinguishing against missed appointments wherein the patient informed the medical professional ahead of time). Corresponding notations may also be added to a patient's record.

As noted above, the illustrative embodiment further comprises trash icon 3208, date navigation toolbar 3218, refresh button 3222, and done button 3220. Dragging and dropping an item over trash icon 3208 may cause the item to be removed from calendar 3202, whether the item is from calendar body 3224, pending bin 3204, or missed bin 3206. A user may select the buttons of date navigation toolbar 3218 to modify the date (or dates) displayed by calendar body 3224. Selecting refresh button 3222 may refresh calendar 3202 by causing mobile device 114 to communicate with application server 102; alternatively, system 100 may be designed to automatically refresh and receive updates, in which case refresh button 3222 may not be required. It will be appreciated that this alternative may apply to system 100 more generally, that is, system 100 may be constructed to have a pull architecture wherein mobile device 114 periodically polls application server 102 to receive updated information (whether done automatically or by user intervention), or a push architecture wherein application server 102 may send updated information to mobile device 114 as required.

Selecting done button 3220 may have the effect of causing mobile device 114 to present the previously displayed GUI screen again.

With reference to FIG. 35, in a further embodiment of the present invention, a user's selection of book appointment button 904 (see FIG. 9) may cause mobile device 114 to present appointment input form 3502 comprising done button 3504, cancel button 3506, staff list 3508, appointment type list 3510, and description field 3512. By selecting a staff member from staff list 3508, selecting an appointment type from appointment type list 3510, and inputting a description into description field 3512, then further selecting done button 3504, a user may create an appointment for scheduling in a fashion analogous to the operation depicted by FIG. 34A. That is, for example, submitting appointment input form 3502 may cause system 100 to “add” the appointment to pending bin 3204, and a user would subsequently be able to schedule this treatment with the patient. Selection of cancel button 3506 has the effect of causing mobile device 114 to discard the received input and cease presenting appointment input form 3502.

In some embodiments of the present invention, book appointment button 904 may be accessible to a user while performing a variety of functions and operations through mobile device 114. For example, book appointment button 904 may both be visible when patient summary 902 is displayed and when treatment plan summary 2920 is displayed. This may be useful as a user may desire to input into system 100 an appointment when performing a variety of functions and operations.

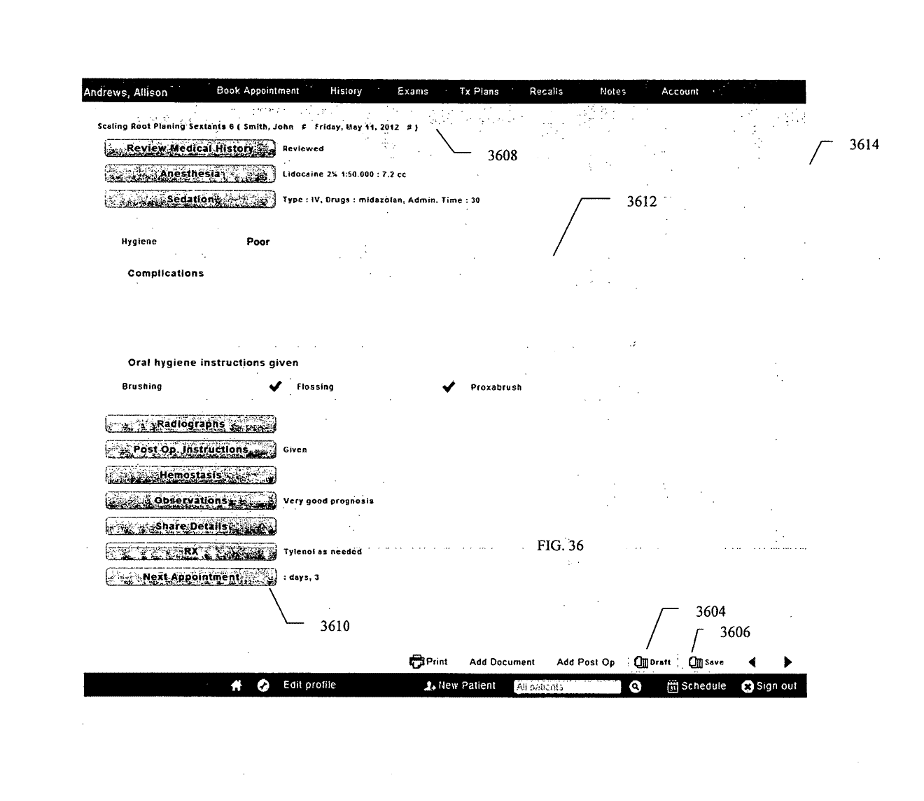

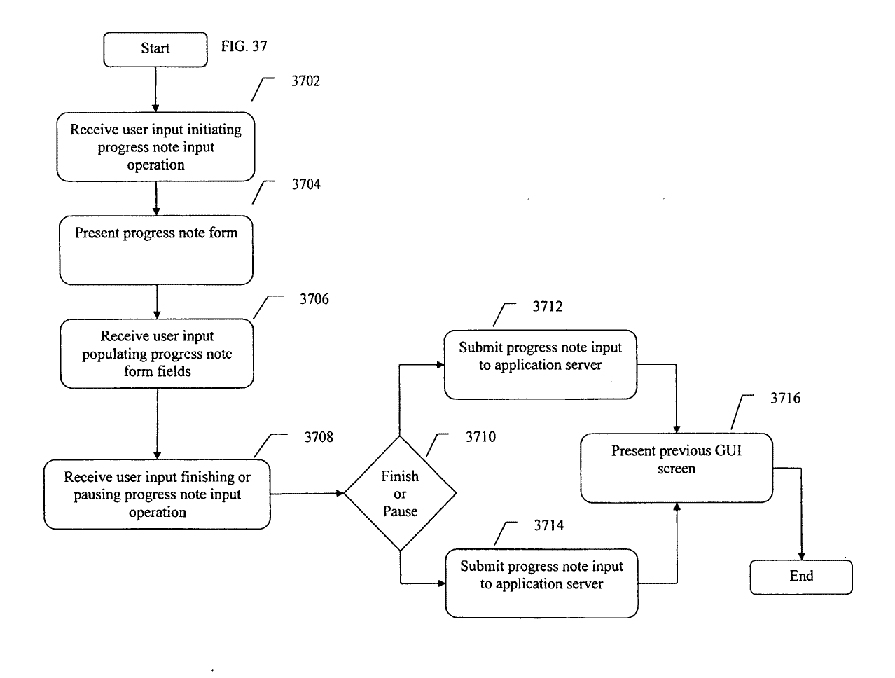

Now with reference to FIG. 36 and FIG. 37, a progress note input operation may be described in greater detail. This operation may be for a user to input notes relating to a patient's treatment.

At step 3702, mobile device 114 may receive user input initiating a progress note input operation. In the illustrative embodiment, this may comprise the combination of a user's selection of a treatment from a treatment plan, such as first scaling treatment 2906 from treatment plan summary 2920 (see FIG. 29), and a user's subsequent selection of document button 2916 (see FIG. 29). In another embodiment of the present invention, the user input may comprise a selection of a scheduled appointment, such as patient appointment 3312 from calendar 3202, and a user's subsequent selection of a contextual menu option thereafter presented for initiating a progress note input operation. In still other embodiments of the present invention, the user input may comprise a selection of a homework item, such as homework item 316 from homework list 304 (see FIG. 3).

At step 3704, mobile device 114 may present progress note form 3614 to a user, comprising:
(a) treatment label 3608 for indicating appointment details; and
(b) progress note form fields 3612 for receiving information relating to the treatment in question, including, for example, whether a patient's medical history was reviewed, whether anaesthesia was used (and if so, details relating thereto), whether sedation was used (and if so, details relating thereto), what hygiene findings were made, what complications were experienced, what hygiene instructions were given, whether radiographs were used, what post operative instructions were given, whether haemostasis was needed, what observations were made, whether details relating to the treatment should be shared, what prescriptions were given, and when the next appointment should be.

At step 3706, mobile device 114 may receive user input populating progress note form fields 3612. In some embodiments, additional forms may be presented to a user to allow additional information to be entered in a structured fashion, or to provide lists or other form elements for a user to select from.

At step 3708, mobile device 114 may receive user input for finishing or pausing the progress note input operation. User input for finishing the operation may correspond to a user's selection of save button 3606. User input for pausing the operation may correspond to a user's selection of save draft button 3604.

At step 3710, mobile device 114 may determine whether it is to finish or pause the progress note input operation on the basis of the input received at step 3708. If mobile device 114 determines it is finish the operation, at step 3712, mobile device 114 may compile and submit the user input received step 3706, along with an indication that the user has sought to finish the operation. If mobile device 114 determines it is pause the operation, at step 3714, mobile device 114 may compile and submit the user input received step 3706, along with an indication that the user has sought to pause the operation.

At step 3716, mobile device 114 may present the GUI screen that was displayed previous to progress note form 3614. For example, if the user input that initiated the progress note input operation comprised the combination of a user's selection of a treatment from a treatment plan, such as first scaling treatment 2906 from treatment plan summary 2920, treatment plan summary 2920 may be displayed again (see FIG. 29). Alternatively, if the user input comprised a selection of a scheduled appointment, such as patient appointment 3312 from calendar 3202, calendar 3202 may be displayed again. In a further alternative, if the user input comprised a selection of a homework item from a homework list displayed in a user's dashboard, such as depicted by FIG. 3 and described in greater detail above, a dashboard such as dashboard 302 may be displayed again.

In various illustrative embodiments of the present invention, there may be one or more consequences to the completion of the above described operation (i.e. of inputting a “progress note”). If the user selected to only pause the operation (i.e. “save a draft”), system 100 may not consider the operation finished and continue, for example, to present a corresponding homework item such as homework item 316 in a user's homework list (see FIG. 3). Alternatively, if the user selected to finish the operation (i.e. “save”), system 100 may consider the operation finished and cease to present a corresponding homework item such as homework item 316 in a user's homework list (see FIG. 3). System 100 may further process the user input received through progress note form fields 3612 to determine and conduct further tasks. For example, system 100 may cause a corresponding appointment to be created (so as to have an analogous outcome as the process depicted by FIG. 34A) if next appointment field 3610 was populated. System 100 may further cause an icon such as documented icon 2922 to appear in a treatment plan summary, this icon potentially having the further purpose of operating as a button that permits a user to select the button so as to cause system 100 to present a summary of the progress note.

In a further alternative of the present embodiment, information received from a plurality of progress note operations, including from multiple users relating to multiple patients, may potentially be aggregated (and potentially annonymized) by system 100 so that further analysis may be conducted on this aggregated data. In some cases, this analysis may be scientific in nature, for example, researchers may seek to access this aggregated data to assess the efficacy of various procedures and drugs. In other cases, this analysis may be commercial in nature, for example, pharmaceutical companies may seek to access this aggregated data to understand the prescribing habits of medical professionals. In other embodiments, system 100 may further aggregate (and potentially annonymize) additional information that it receives, for example, the results of patient examinations. This may be for similar purposes, such as, for example, enabling a researcher to obtain a statistically relevant sample relating to the long-term outcomes of a particular procedure or use of a drug.

All publications and patent applications mentioned in this specification are herein incorporated by reference to the same extent as if each individual publication or patent application was specifically and individually incorporated by reference.

While the foregoing invention has been described in some detail for purposes of clarity and understanding, it will be appreciated by one skilled in the art, from a reading of the disclosure, that various changes in form and detail can be made without departing from the true scope of the invention.

1. A computer-implemented method of assembling a medical treatment plan for a patient, said method comprising:
presenting, by a computer system, a first treatment option and a second treatment option;
receiving, at said computer system, a first selection of said first treatment option;
receiving, at said computer system, a second selection of said second treatment option;
generating, with said computer system and as a function of said received first selection of said first treatment option and said received second selection of said second treatment option, said medical treatment plan for said patient; and
storing, in said computer system, said medical treatment plan for said patient;
wherein said first treatment option and said second treatment option are presented in an order corresponding to a pre-determined medical relationship between said first treatment option and said second treatment option.

2. The computer-implemented method of claim 1 wherein said medical treatment plan comprises indications that a first treatment and a second treatment are to be administered to said patient, wherein said first and second treatments respectively correspond to said first and second treatment options.

3. The computer-implemented method of claim 2 wherein said order comprises said first treatment option being presented before said second treatment option; and
wherein said medical relationship comprises said first treatment being administered before said second treatment if both of said first and second treatments are to be administered to said patient.

4. The computer-implemented method of claim 2 wherein said order comprises the chronological sequence in which said first and second treatments are administered.

5. The computer-implemented method of claim 2 wherein said medical relationship between said first treatment option and said second treatment option comprises one of (a) said first and second treatments being administered jointly to said patient; and (b) said first and second treatments each being administered to the exclusion of the other.

6. The computer-implemented method of claim 1 further comprising:
receiving, at said computer system, an indication that a third treatment option different from said first and second treatment options should be presented in a given position relative to said first and second treatment options;
wherein said presenting, by a computer system, a first treatment option and a second treatment option for said medical treatment plan further comprises presenting said third treatment option, and
wherein said third treatment option is presented in said given position relative to said first and second treatment options.

7. The computer-implemented method of claim 1 wherein at least one of said first and second treatment options comprises a submenu.

8. The computer-implemented method of claim 1 wherein at least one of said first and second treatment options corresponds to a specific treatment.

9. The computer-implemented method of claim 1 wherein presenting, by a computer system, said first treatment option and said second treatment option comprises presenting said first treatment option and said second treatment option as part of a list of at least three treatment options.

10. A computer-implemented method of assembling a medical treatment plan for a patient, said method comprising:
presenting, by a computer system, a first treatment option and a second treatment option;
presenting, by said computer system, a graphical representation corresponding to a plurality of individual anatomical elements of said patient;
receiving, at said computer system, a selection of one of said first and second treatment options;
receiving, at said computer system, a selection of at least one individual anatomical element of said patient;
generating, with said computer system and as a function of said received selection of one of said first and second treatment options and said received selection of at least one individual anatomical element of said patient, said medical treatment plan for said patient; and
storing, in the computer system, said medical treatment plan for said patient;
wherein said first treatment option and said second treatment option are presented in an order corresponding to a pre-determined medical relationship between said first treatment option and said second treatment option.

11. The computer-implemented method of claim 10 wherein said graphical representation corresponding to a plurality of individual anatomical elements of said patient comprises an odontogram.

12. The computer-implemented method of claim 10 wherein said graphical representation corresponding to a plurality of individual anatomical elements of said patient comprises at least one indicator of a finding related to at least one of said plurality of individual anatomical elements of said patient.

13. The computer-implemented method of claim 10 wherein said medical treatment plan comprises an indication that a first treatment corresponding to said selected one of said first and second treatment options is to be administered to said selected at least one individual anatomical element of said patient.

14. The computer-implement method of claim 10 further comprising:
receiving, at said computer system, a further selection of said first and second treatment options;
receiving, at said computer system, a further selection of at least one individual anatomical element of said patient;
wherein said medical treatment plan for said patient further comprises an indication that a second treatment corresponding to said further selected one of said first and second treatment options is to be administered to said further selected at least one individual anatomical element of said patient.

15. A computer-implemented method for manipulating a medical treatment plan for a patient, said method comprising:
receiving, at a computer system, indications corresponding to first and second treatments to be administered to said patient;
associating, by said computer system, at least one of said first and second treatments with a pre-determined duration; and
presenting, by said computer system, graphical representations of said first and second treatments and said associated pre-determined duration.

16. The computer-implemented method of claim 15, wherein associating, by said computer system, at least one of said first and second treatments with a pre-determined duration comprises associating, by said computer system, said first and second treatments with a first and second pre-determined duration, respectively, and wherein said method further comprises:
receiving, at said computer system, an indication that said first and second treatments should be grouped together; and
presenting, by said computer system, an updated graphical representation of said first and second treatments grouped together and associated with said first and second pre-determined durations.

17. The computer-implemented method of claim 15, wherein said graphical representations of said first and second treatments are presented in a first order, and wherein said method further comprises:
receiving, at said computer system, an indication that said first and second treatments should be in a second order; and
presenting, by said computer system, an updated graphical representation of said first and second treatments in said second order.

18. The computer-implemented method of claim 15 wherein said computer system is a first computer system, said method further comprising:
receiving, at said first computer system, an indication to schedule at least one of said first and second treatments;
transmitting, from said first computer system to a second computer system, a first indication that said at least one of said first and second treatments should be scheduled;
transmitting, from said second computer system to a third computer system, a second indication that said at least one of said first and second treatments should be scheduled;
presenting, at said third computer system, a graphical representation that said at least one of said first and second treatments should be scheduled;
receiving, at said third computer system, an indication that said at least one of said first and second treatments is scheduled for a given time; and
presenting, at said third computer system, an updated graphical representation that said at least one of said first and second treatments has been scheduled.

19. The computer-implemented method of claim 18 further comprising:
receiving, at said third computer system, an indication that said patient missed said at least one of said first and second treatments scheduled for said given time; and
presenting, at said third computer system, a graphical representation that said at least one of said first and second treatments should be rescheduled.

20. A computer readable memory storing computer executable instructions thereon that when executed by a computer performs the method of claim 1.
